(19) United States
(12) Patent Application Publication
(10) Pub. No.: US 2002/0099738 A1
(43) Pub. Date: Jul. 25, 2002

(54) Automated web access for back-end enterprise systems

(76) Inventor: Hugh Alexander Grant, Dublin (IE)

Correspondence Address: PENNIE AND EDMONDS, 1155 AVENUE OF THE AMERICAS, NEW YORK, NY, 100362711

(21) Appl. No.: 09/990,540

(22) Filed: Nov. 21, 2001

Related U.S. Application Data
(60) Provisional application No. 60/252,483, filed on Nov. 22, 2000.

(51) Int. Cl. G06F 15/00

(52) U.S. Cl. 707/513

(57) ABSTRACT

A method and system for integrating back-end enterprise applications with Web clients is disclosed. One preferred embodiment comprises a method for invoking an object, comprising the steps of generating a description of the interface of the object; generating metadata representing the interface of the object from the description; storing the metadata; generating a representation of an invocation of the object in a markup language from the metadata; transmitting the representation of the invocation to a client program configured to invoke the object by interpreting the representation; receiving an invocation from the client program; based on the metadata, interpreting the received invocation. In one preferred embodiment, Web clients comprise Web applications generated automatically from CORBA IDL files describing interfaces to objects in the back-end enterprise applications.

### CROSS REFERENCE To RELATED APPLICATIONS

This application is related to the U.S. provisional application Ser. No. 60/252,483 filed on Nov. 22, 2000 and entitled METHOD AND SYSTEM FOR GENERATING WEB FORMS FOR INVOKING SOFTWARE OBJECTS.

### FIELD OF THE INVENTION

The major field of the invention is the integration of enterprise and legacy computing applications with the Internet to provide access to HTTP clients, and more particularly the automated generation of Web pages, Web applications, or Web services, and intermediate modules to enable bidirectional access from the web to enterprise and legacy computing applications having defined interfaces.

### BACKGROUND OF THE INVENTION

A successful electronic business system must expose server-side applications to customers, partners, suppliers, and employees through standard Internet technologies such as extensible markup language (XML) and hypertext markup language (HTML). Moreover, the system must achieve this while protecting ongoing investment in server-side technologies, many of which were initially implemented before the Internet came into being.

Platform- and language- agnostic integration solutions such as the Common Object Request Broker Architecture (CORBA) have been used to integrate many traditional and legacy server solutions into more modern distributed environments. However, integration of these multi-tiered distributed computing environments with standard Internet technologies such as XML and HTML poses unique problems, in part because the skills needed and the goals and deployment cycles differ substantially at each tier. Graphic designers and HTML developers have different skills and typically work on shorter deployment cycles than developers that provide mainframe transaction processing systems. Similarly, Internet protocols and markup languages are traditionally humanly readable, and may thus be edited by hand. CORBA, by contrast, is a binary protocol that is not humanly readable and is therefore typically more difficult to develop.

These drawbacks are significant due to the costs already sunk into existing enterprise applications and the costs, such as retraining of enterprise program developers, required to transition enterprise computing to a more Web-friendly paradigm. Developers of back-end enterprise applications may be skilled in distributed programming but typically require training to learn the various languages and design tools for generating Web applications (including Web pages or Web services). On the other hand, developers of Web applications typically are not skilled in enterprise computing techniques.

There have been many attempts to integrate Web access with enterprise computing. Some examples include the solutions provided by WEBMETHODS®, Inc., ROGUEWAVE SOFTWARE® XORBA and OpenFusion® by PRISM TECHNOLOGIES™. These solutions require programming by developers skilled in not only Internet technologies but also possessing a good understanding of distributed object-oriented programming, and technologies like JAVA, CORBA, J2EE and the like.

ROGUEWAVE XORBA™ enables an XML-CORBA link, but requires that the developer implementing the solution copy and paste IDL or SQL statements reflecting business logic to generate XML output. The advantage offered by this ‘light weight’ strategy is the elimination of the need to learn a new scripting language, new APIs or proprietary interfaces. The cost is that the developer should be familiar with IDL and the business logic to accurately, although laboriously, carry out the cut and paste operations. In view of the hundreds or even thousands of IDL statements that need to be transported to XML in a single enterprise, this is no small undertaking. Moreover, any changes to the interfaces results in a repetition of the laborious exercise.

Therefore, existing technology fails to efficiently integrate HTML compatible technologies such as Web browsers to extend the reach of enterprise computing.

### SUMMARY OF THE INVENTION

In one aspect, the present invention automatically generates Internet clients for back-end server systems. In one preferred embodiment, the present invention automatically generates HTTP interfaces for back-end CORBA enterprise applications and Web applications for invoking those interfaces. The HTTP interfaces are preferably generated from existing CORBA Interface Definition Language (IDL) descriptions of interfaces to the back-end applications. In another preferred embodiment, the invention automatically generates HTTP interfaces for back-end Enterprise Java Bean (EJB) enterprise applications and Web applications for invoking those interfaces. The HTTP interfaces are preferably generated from existing EJB interfaces analyzed using reflection. Any language or system exposing interface definitions such as through an interface definition language, an interface repository, or introspection can be similarly supported.

The HTTP interfaces are advantageously implemented with commonly used markup languages such as HTML or XML and enable web developers to directly further modify the generated Web applications without learning enterprise programming.

In another aspect, the present invention allows developers of enterprise applications to maintain and further customize their applications in a familiar web environment without having to learn advanced Web application programming.

A preferred system for generating a Web client is a computer configured to acquire one or more interface descriptions, generate metadata from the interface descriptions, and generate HTML files from the metadata. One such preferred system is configured to parse one or more IDL files, generate metadata from the parsed IDL, and generate HTML files from the metadata. Another such preferred system is configured to acquire interface descriptions from in interface repository, such as a CORBA interface repository. Another such preferred system is configured to acquire interface description information from object implementations using introspection, such as Java reflection.

In still another aspect, the invention provides an application programming interface (API) suitable for allowing JAVA programs to communicate with CORBA objects via Simple Object Access Protocol (SOAP) messages. The API permits JAVA programs not necessarily otherwise compliant with CORBA, to access CORBA-based applications across the Web. Moreover, the JAVA programmer need not understand either SOAP, CORBA, or XML to take advantage of this facility.

In still another aspect, the system and method of the invention provide an Interceptor API enabling access to and modification of messages exchanged between parts of the system. Thus, messages invoking a CORBA object may be examined, modified, or consumed by an application prior to the invocation of the CORBA object. Interceptors register with the system, defining the types of message they are to be passed. Registered Interceptors are passed the object identifier, interface definition, the operation requested from invocations they receive and the parameters in the invocation. Similar interception is enabled for invocation responses. Consequently, a developer may modify the result returned from the CORBA object before it is delivered to the invoking process or prevent or modify the invocation of the CORBA object.

### DETAILED DESCRIPTION OF THE DRAWINGS

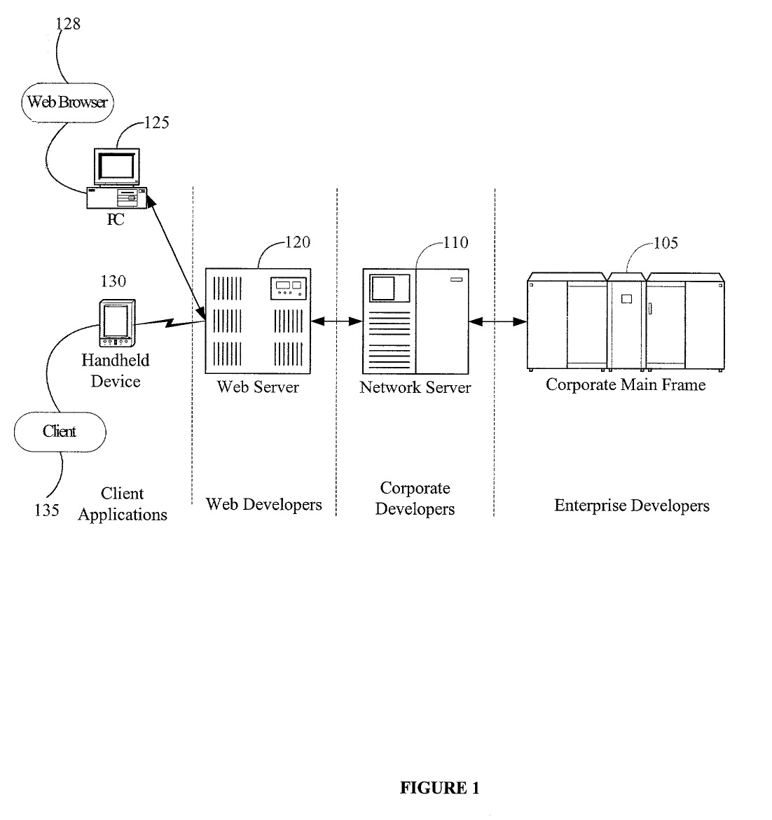

FIG. 1 schematically illustrates the architecture of an exemplary computing environment for practicing the invention;

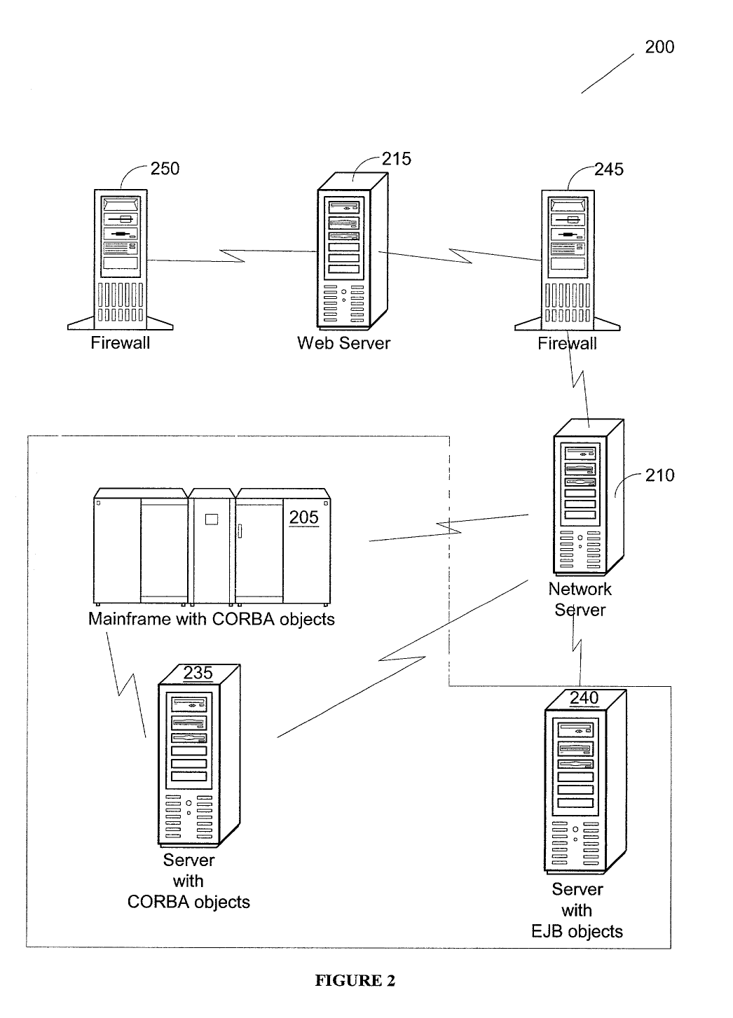

FIG. 2 schematically illustrates the architecture of another exemplary computing environment for practicing the invention;

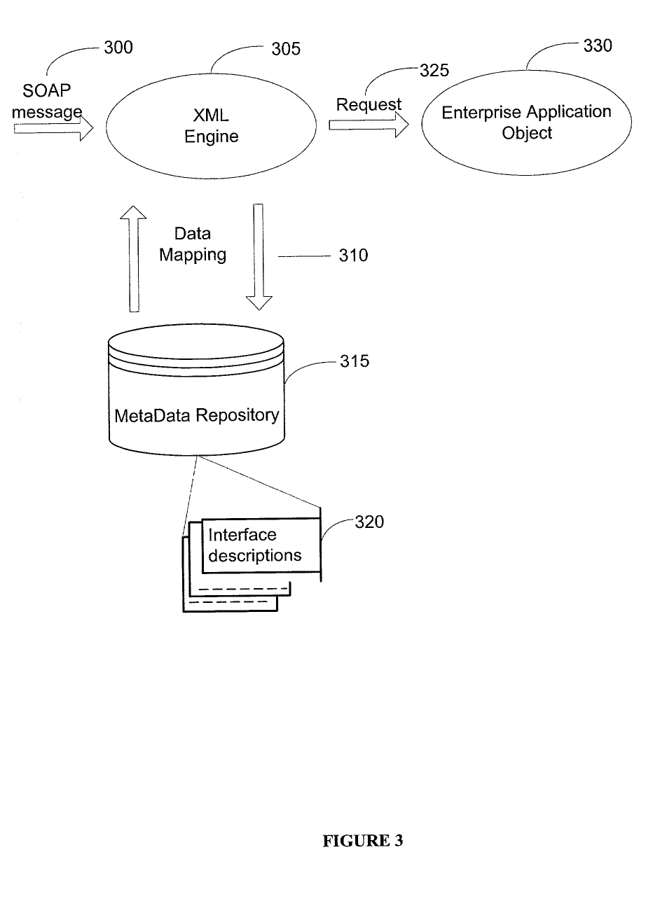

FIG. 3 schematically illustrates interaction between components in an exemplary embodiment of the invention;

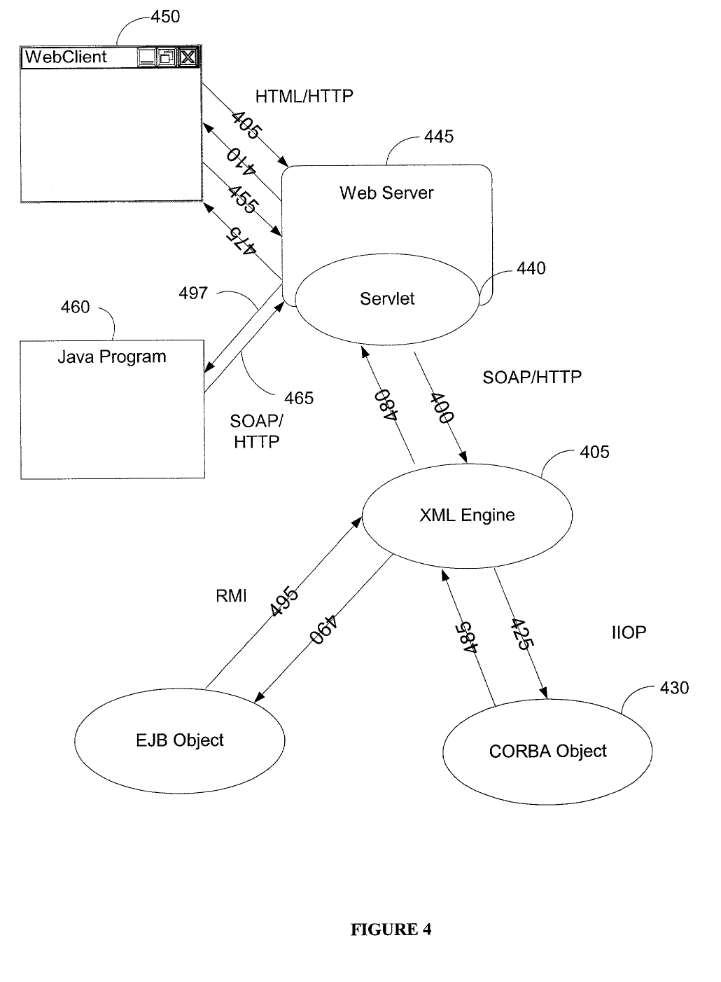

FIG. 4 schematically illustrates various interactions for invoking services from a CORBA object of interest and receiving the results in an exemplary embodiment of the invention;

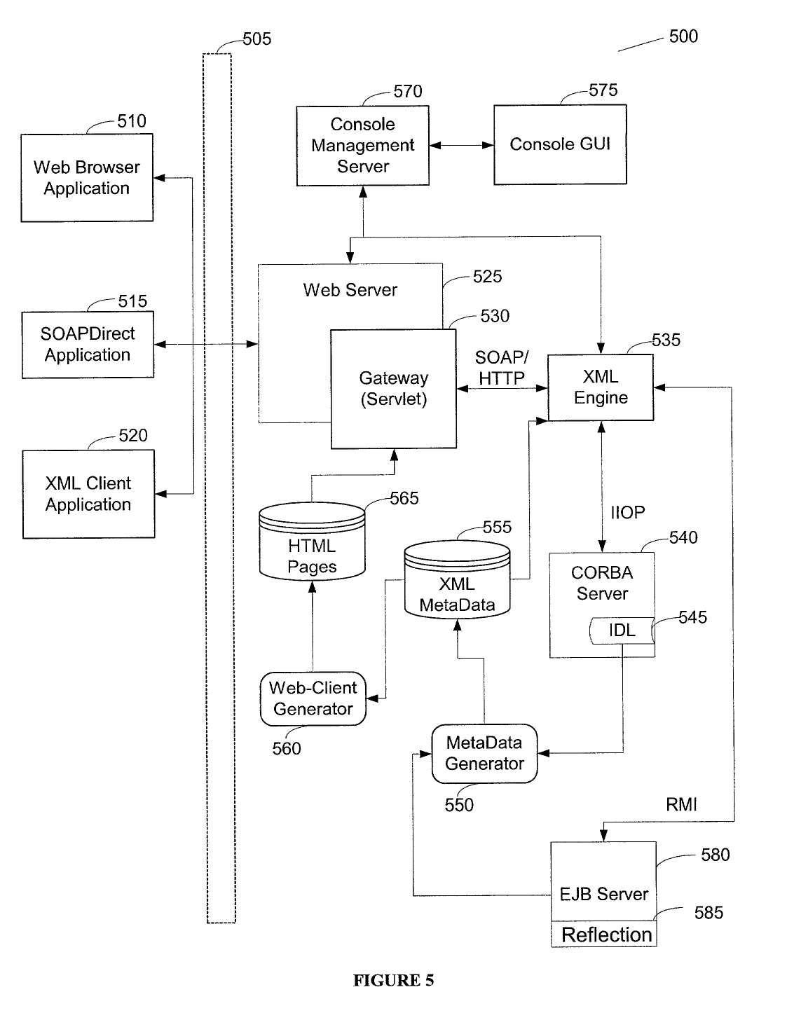

FIG. 5 schematically illustrates one preferred architecture for practicing the invention;

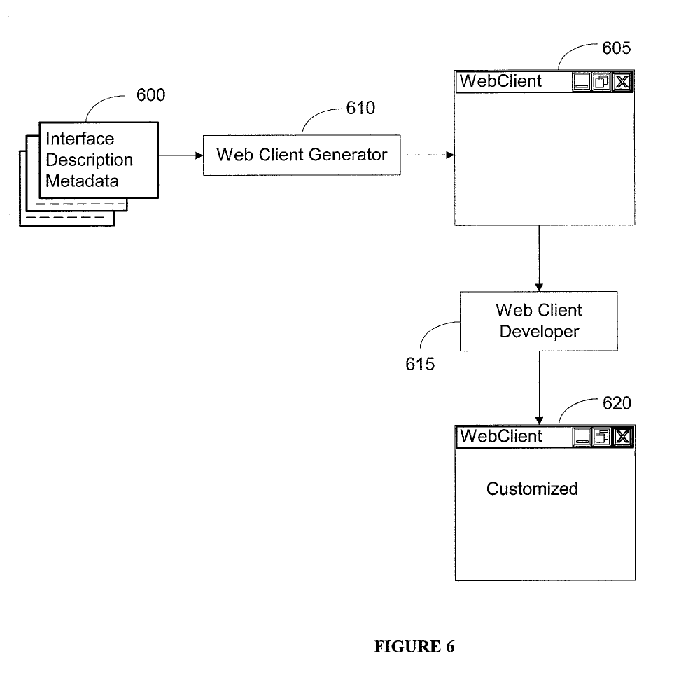

FIG. 6 schematically illustrates the generation and customization of Web client pages;

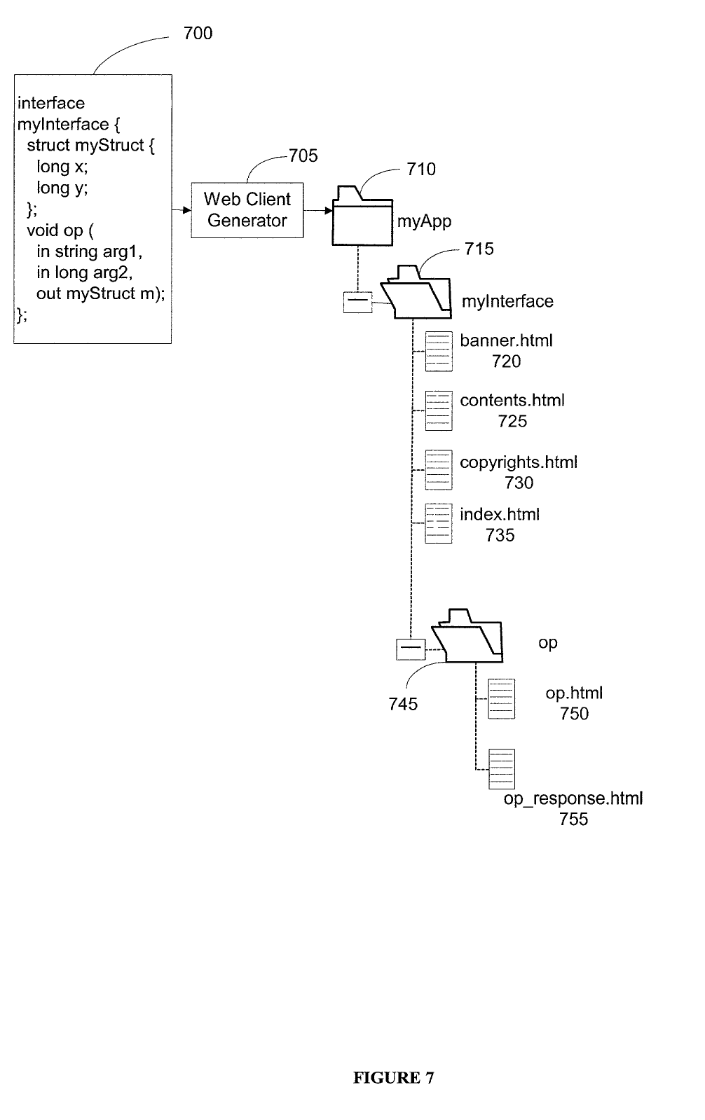

FIG. 7 schematically illustrates a preferred structure for organizing generated Web applications;

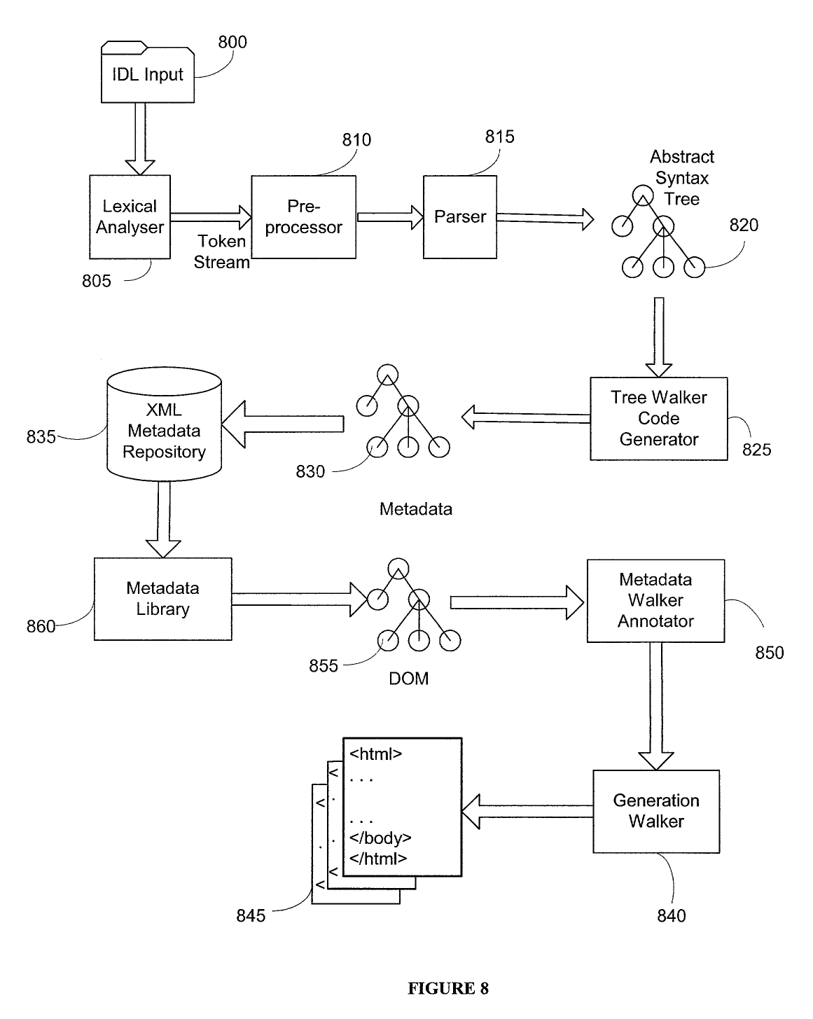

FIG. 8 schematically illustrates automatic generation of Web applications from an IDL description of an interface;

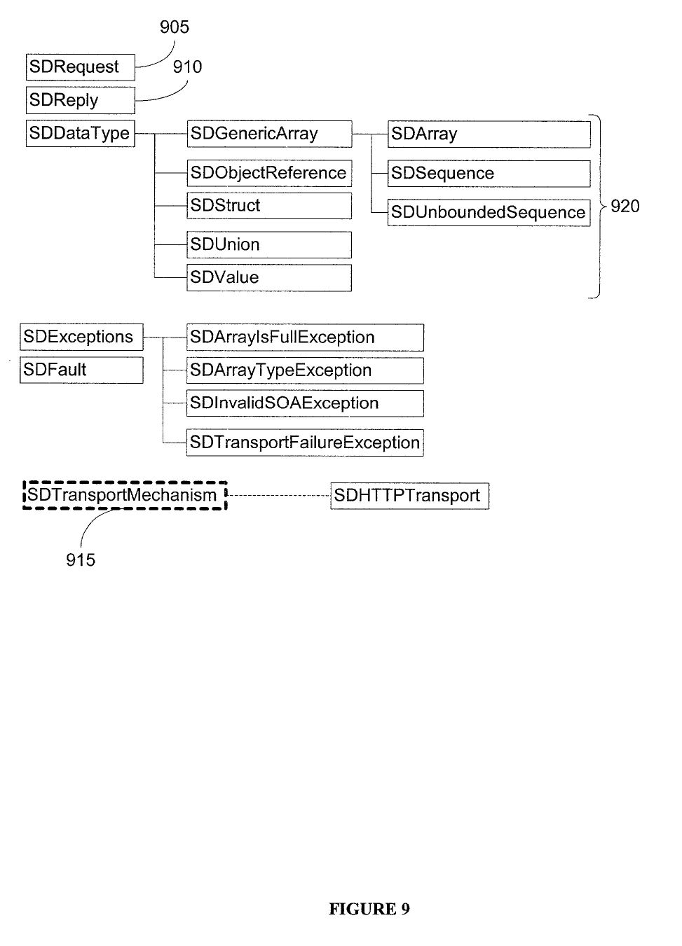

FIG. 9 schematically illustrates an overview of the SOAPDirect classes;

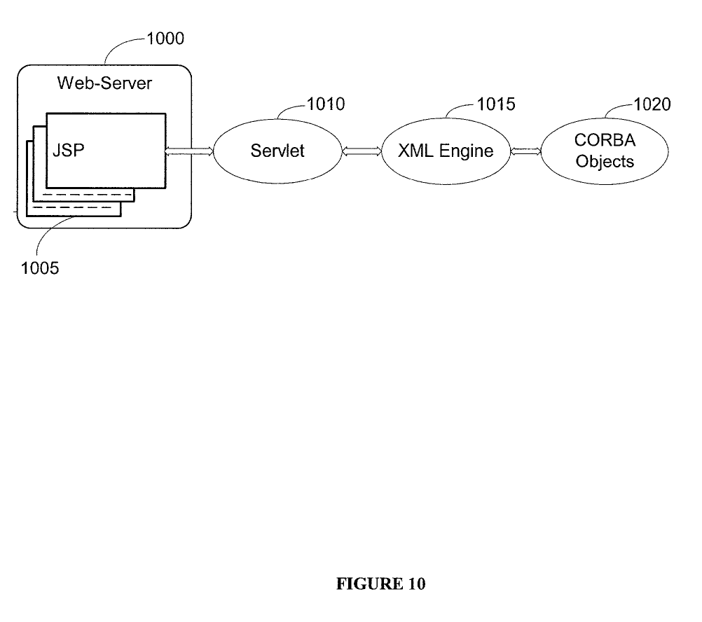

FIG. 10 schematically illustrates connectivity between JSP and the XML infrastructure enabled by SOAPDirect;

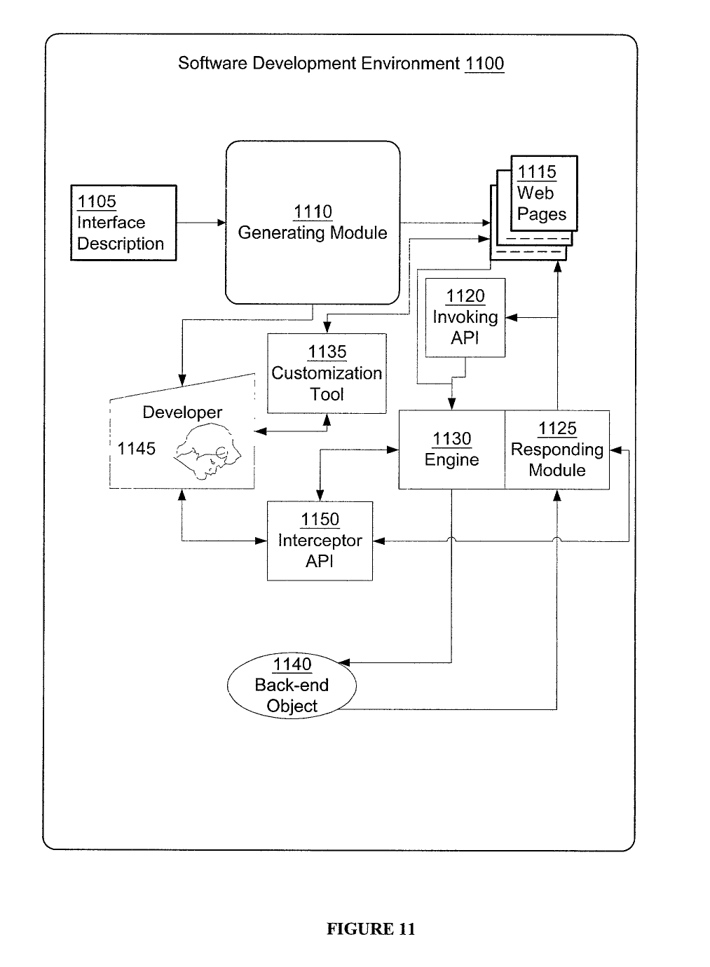

FIG. 11 illustrates a development environment facilitating development of Web client pages;

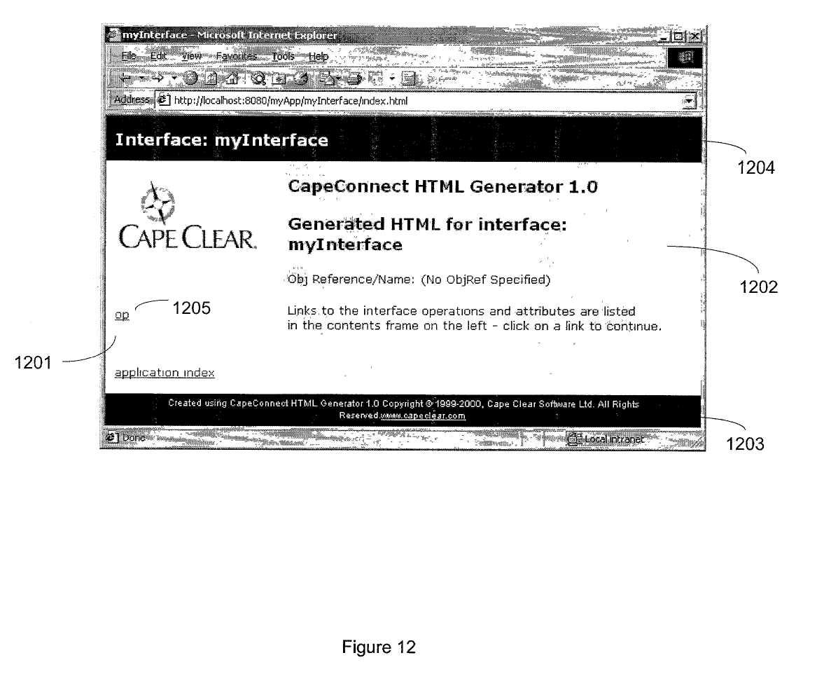

FIG. 12 schematically illustrates a default Web application rendered from HTML by a Web browser for a CORBA IDL interface myInterface;

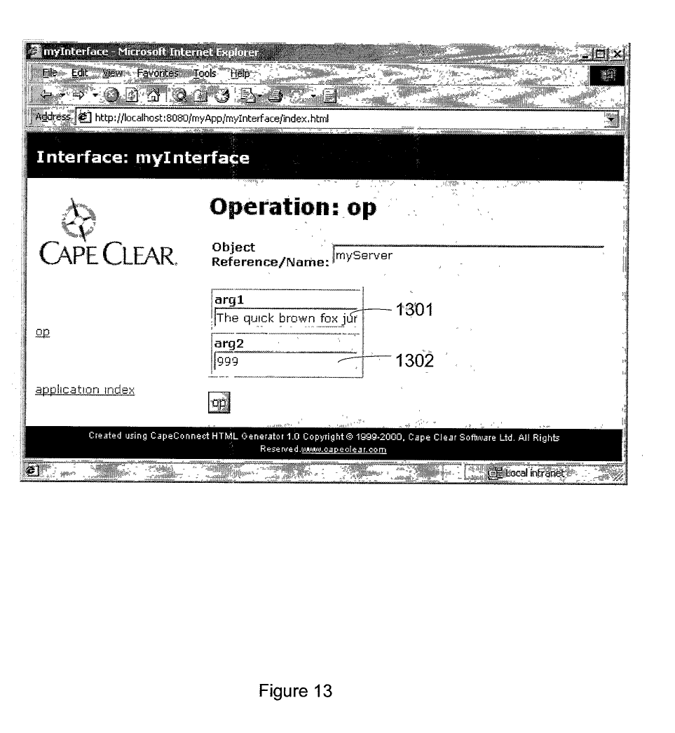

FIG. 13 schematically illustrates a Web application rendered from HTML by a Web browser for invoking a CORBA IDL operation op from interface myInterface;

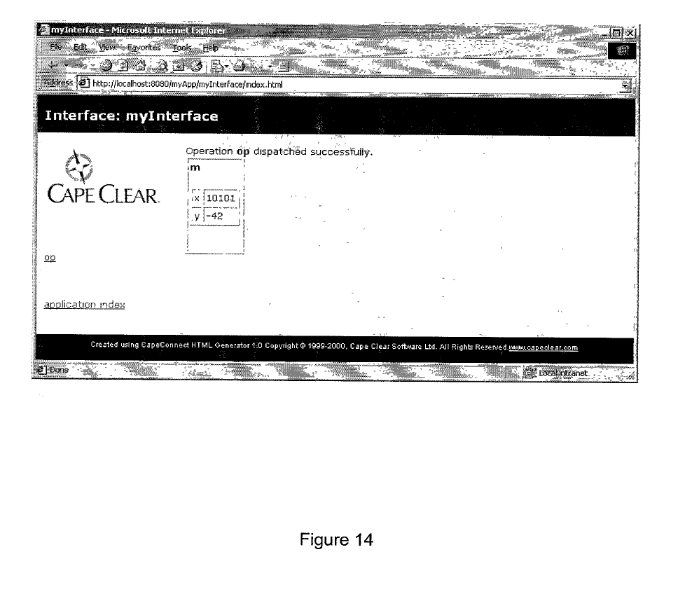

FIG. 14 schematically illustrates a Web application rendered from HTML by a Web browser providing the return values from invoking a CORBA IDL operation op from interface myInterface;

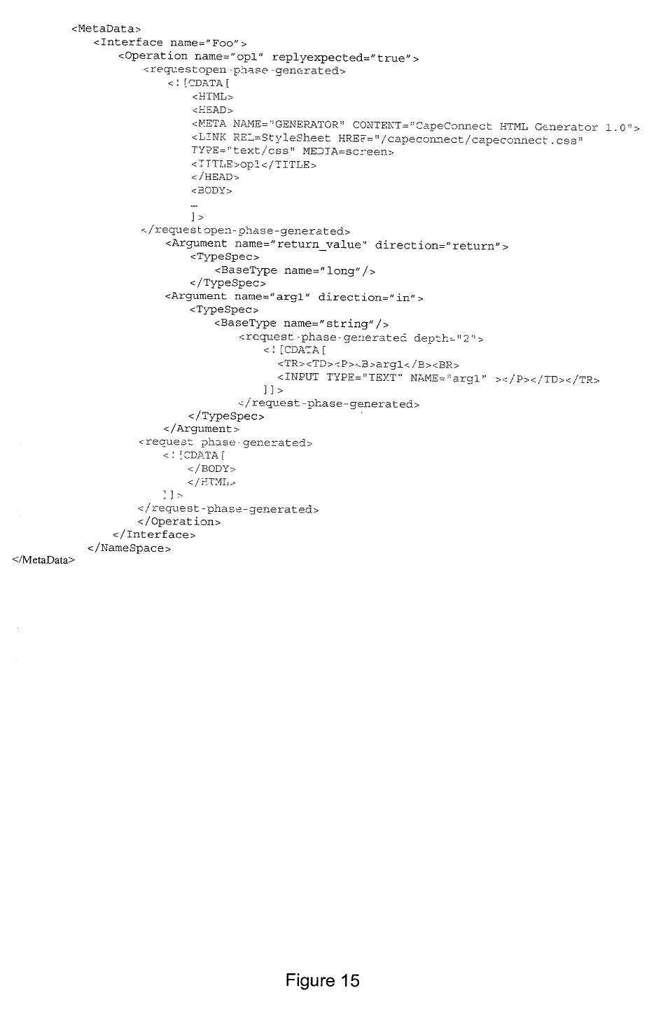

FIG. 15 illustrates a preferred example XML metadata document describing CORBA IDL operation op from interface Foo annotated with HTML.

### DETAILED DESCRIPTION OF THE INVENTION

The CapeConnect™ service delivery platform, manufactured by Cape Clear® Software, Ltd. of Dublin, Ireland, is a preferred example embodiment of the present invention. The invention integrates well-known standards enjoying widespread acceptance to enable interactivity between the disparate components characterizing enterprise computing and Web access in a cost efficient and timely fashion.

The invention is described below with the aid of figures depicting various embodiments. However, the embodiments and their respective computing environments are intended to be illustrative rather than limitations on the scope of the invention.

FIG. 1 depicts a computing environment 100, in which the present invention may be advantageously deployed, along with different developer communities conventionally involved. At one end corporate mainframe 105 represents enterprise computing resources. Corporate mainframe 105 typically executes business-critical applications, such as transaction processing, often in highly optimized and tested code. Such software requires skilled enterprise developers for creation and maintenance.

Corporate mainframe 105 is typically connected to network server 110 providing middleware and business logic. Programming and maintaining such systems requires the skills of corporate developers for making different programs interact in the intended manner, e.g., for inventory management in a distributed organization.

At the other end of this multiple-tier (three are shown but more are not uncommon) arrangement are client systems, for example workstations or personal computers 125, or handheld devices 130, and client applications 128, 135 interacting with Web server 120. Web server 120 interacts with network server 110 and thereby with corporate mainframe 105. For example, client applications 128 running on personal computer 125 may query for prices or delivery schedules of interest in the course of commerce while client application 135 running on handheld device 130 might request an update on the number of widgets available in the inventory for use in a face-to-face meeting with a potential client. The present invention is preferably deployed in conjunction with Web server 129 and network server 110 to simplify the task of developing web applications that interact with back-end systems running on systems like corporate mainframe 105.

FIG. 2 illustrates an alternative system architecture 200 incorporating firewalls to restrict access to corporate resources and yet enable Web access. Mainframe 205 communicates with network server 210. Network server 210 also communicates with a server with CORBA objects 235 and a server with EJB objects 240. Web server 215 accesses network server 210 via firewall 245. Access to Web server 215 by external machines is via another firewall 250. Firewall 245 provides security to the back-end applications while firewall 250 provides security to Web server 215 and a higher level of security for the systems behind firewall 245.

In the context of FIGS. 1-2, Web servers 115 and 215 host Web applications developed and maintained by Web developers. The technology for creating and modifying Web applications and applications is different from the techniques required to write and maintain back-end applications. Web developers are often unfamiliar with IDL or distributed object-oriented programming. While much of the discussion and illustrative embodiments focus on CORBA and JAVA, the teachings of the present invention are also applicable to other distributed programming environments including RPC, NEO and COM/DCOM as will be apparent to one of ordinary skill in the art.

FIG. 3 illustrates an exemplary embodiment of the invention for processing a SOAP message 300 invoking an enterprise application object 330. SOAP message 300 is parsed by XML engine 305 to construct a corresponding request 325 to the enterprise application object 330. XML engine 305 is implemented on a server, such as network server 110 of FIG. 1 or network server 210 of FIG. 2. Enterprise application object 330 may execute on a back-end computer, such as the mainframe 105 of FIG. 1 or server with CORBA objects 235 or server with EJB objects 240 or mainframe with CORBA objects 205 of FIG. 2. In alternative embodiments of the invention, a single server could provide both CORBA objects and implement the XML engine, and/or a Web server. A wide variety of deployment configurations are possible, as will be apparent to one of skill in the field.

Typically, Enterprise application object 330 conforms to a distributed computing standard, such as EJB or CORBA, although this is not a requirement for practicing the invention. Any network accessible resource may be accessed using the system of the invention. In order to construct request 325 from SOAP message 300, XML engine 305 communicates with metadata repository 315 for data defining a mapping of SOAP message 300 onto one or more interfaces of Enterprise Application Object 330. A given mapping may encompass more than one enterprise application object and/or more than one request, although only one request 325 and one enterprise application object 330 are illustrated for convenience. Once the correct mapping for the XML message is located, XML engine constructs request 325 conforming to the mapped interface and sends the request 325 to Enterprise application object 330.

FIG. 4 schematically depicts the XML engine of FIG. 3 included in a larger context configured to service requests for CORBA and EJB services from a conventional Web client 450 such as a Web browser and a SOAP client such as a SOAPDirect Java program 460.

Web client 450, sends request 405 to Web server 445 for a Web application comprising HTML for invoking an interface of CORBA object 430. Web server 445 responds by sending 410 the Web application in a conventional HTTP response. After providing any necessary parameters, the user invokes a form on Web client 450, causing Web client 450 to send an HTTP request to 455 servlet 440 via Web server 445. Request 455 is preferably determined using the IDL-to-HTML mapping described below.

Servlet 440 translates the request 455 into XML and constructs a SOAP request containing the translated information from request 455. The servlet 440 then sends the SOAP request 400 to XML engine 405. As described more fully below, XML engine parses and transforms the SOAP request into an appropriate CORBA invocation and calls sends the CORBA invocation 425 to CORBA object 430, preferably via CORBA Internet Inter-ORB Protocol (IIOP). Other CORBA transport protocols may be used in place of IIOP.

In response to request 425 for services, CORBA object 430 sends response 485 back to XML Engine 405. XML Engine 405 converts the results into XML and sends the results as a SOAP message 480 to servlet 440. Servlet 440 transforms the XML results from SOAP message 480 into an HTML Web application (preferably by populating an HTML template) and sends the resulting Web application to Web client 450 via HTTP 475

Communication of an invocation and response of CORBA object 430 with Java program 460 is similar, except both invocation and response would be SOAP messages. Rather than transforming requests and responses from and to HTML, servlet 440 preferably passes the SOAP between Java program 460 and XML engine 405 unmodified in this case. Invocation of an EJB object instead of a CORBA object is also similar, with communication between XML engine 405 and EJB object preferably being Java RMI (although other protocols could be used, including IIOP).

FIG. 5 schematically illustrates the XML engine, Web server and servlet illustrated in FIG. 4 in a larger context including metadata generator 550 for generating metadata from interface descriptions and Web client generator 560 for generating Web applications for accessing the HTTP interface to CORBA and EJB objects provided by the XML engine 535, servlet 530 and Web server 525. Also illustrated are firewall 505 and clients such as Web browser 510, SOAPDirect application 515 and XML application 520.

Communication with client applications 510, 515, 520 is preferably via HTTP. Web browser 510 typically communicates using HTML over HTTP, while SOAPDirect application 515 and XML client application 520 preferably use SOAP over HTTP.

Web server 525 mediates HTTP communications with clients 51, 515, 520, while gateway servlet 530 communicates with XML engine 535 via SOAP over HTTP. XML engine 535 preferably communicates with CORBA server 540 via Internet Inter-Orb Protocol (IIOP) and with EJB Server 580 via Java RMI.

The system enables developers unfamiliar with SOAP, CORBA and EJBs to automatically generate metadata 555 and HTML pages 565 that permit Web browser 510 to communicate requests to and receive results from CORBA and EJB objects via Web server 525, servlet 530 and XML engine 535. Servlet 530 transparently converts the HTML/HTTP requests into SOAP messages for processing by XML engine 535.

The automatically generated system also supports SOAP clients 515, 520. Requests received in SOAP, e.g., from SOAPDirect client application 515 are preferably simply passed through to XML engine 535 without translation.

XML engine 535 transparently converts the SOAP messages into the appropriate back-end server object invocations, such as CORBA/IIOP invocations and EJB invocations. The conversion of SOAP messages into back-end object invocations (and vice-versa) by XML engine 535 is based on the received SOAP request and mapping information from XML metadata repository 555. The metadata is automatically generated from existing interface descriptions by metadata generator 550.

In one preferred embodiment XML engine 535 performs the functions of the Web client generator 560 and the metadata generator 550.

Generation of Metadata from Interface Descriptions

Metadata generator 550 automatically generates metadata from descriptions of the interfaces selected by a developer. The developer need not be familiar with IDL or Java. This metadata, stored in XML metadata repository 555, enables XML engine 535 to map XML constructs to corresponding interface parameters.

Generation of Metadata from IDL

A preferred example of generation of metadata from CORBA IDL is performed as schematically illustrated in FIG. 8. IDL input 800 is subjected to lexical analysis by lexical analyzer 805 to create a token stream. The token stream is pre-processed by preprocessor 810 and passed to parser 815. Parser 815 generates an abstract syntax tree 820 representing in a data structure the syntactic structure of the IDL input 800. Tools for lexing, preprocessing and parsing CORBA IDL are available from a variety of sources known to those of skill in the CORBA field.

The abstract syntax tree 820 produced by parser 815 is processed by tree walker code generator 825 to transform the tree into metadata 830 that describes the abstract syntax tree 825. The tree walker traverses the abstract syntax tree (using known tree-traversal algorithms) and preferably maps the nodes and arcs of the tree representing parsed IDL elements into nodes and arcs corresponding to XML elements according to the IDL to XML mapping described below. In a preferred embodiment, the XML metadata 830 representation of the IDL input 800 is stored in XML metadata repository 835 (shown in FIG. 5 as 555).

IDL to XML Mapping

For the preferred example CORBA embodiment, an IDL to XML mapping is provided in detail.

Root Element

The root element tag is <Metadata>

Modules

Modules are mapped to the XML tag <Namespace>. The attribute name is the modules' name.

| For example, | |
|---|---|
| IDL: | module SDeskApp {}; |
| maps to: | |
| XML: | <Namespace name=“SDeskApp”> |
| | <Namespace> |

User Types

Types such as structs, enums etc use the <TypeSpec> tag. A TypeSpec can declare a new type, by declaring the new type, or refer to a previously declared type using the <ScopedName> tag along with the name attribute to refer to the name of the type.

Base Types

There are a number of base types available. These base types correspond to the basic IDL types and the void type. These are shown using the <BaseType> tag. BaseTypes have a name attribute representing their type. Also strings have a bound attribute. Unbounded strings have bound set to 0.

The basic IDL types are, short, long, unsigned short, unsigned long, long long, unsigned long long, float, double, char, wchar, string, wstring, Boolean, octet, fixed and any. In a preferred embodiment, the any type is not supported.

For example,

IDL: struct NumberAnalysis {

string zoneName;
long zoneId;
NAType type;
float rate;
ChargePlan chargePlan;
long naId;

};

maps to:
XML: <TypeSpec>

<Struct name=“Product”>

<Field name=“zoneName”>

<TypeSpec>

<BaseType name=“string” bound =“O”/>

<TypeSpec>

</Field>
<Field name=“zoneId”>

<TypeSpec>

<BaseType name=“long”/>

</TypeSpec>

</Field>
<Field name=“type”>

<TypeSpec>

<ScopedName name=“SICTeller.NAType”/>

</TypeSpec>

</Field>
<Field name=“rate”>

<TypeSpec>

<BaseType name=“float”/>

</TypeSpec>

</Field>
<Field name=“chargePlan”>

<Type Spec>

<ScopedName name=“SICTeller.ChargePlan”/>

</TypeSpec>

</Field>
<Field name=“naId”>

<TypeSpec>

<BaseType name=“long”/>

</Type Spec>

</Field>

</Struct>

</TypeSpec>

Enums are mapped to the XML tag <Enum>. The Enum XML tag is allowed to have a name attribute that is the enum's name. An Enum literal uses the <EnumLiteral> tag inside the <Enum> scope and also has a name attribute.

For example,

| | |
|---|---|
| IDL: | enum ProductName {CCX_html, CCX_xml}; |

maps to:
XML:

<TypeSpec>

<Enum name=“ProductName”>

<EnumLiteral name=“CCX_html”/>
<EnumLiteral name=“CCX_xml”/>

</Enum>

</TypeSpec>

Struct

The <Struct> tag is used to represent a CORBA Struct. The name of the struct is given in the name attribute. The <Field> tag represents each field in the struct, and the field's name is given in the attribute of the tag. Inside this element the <TypeSpec> tag is used to define the type of the field.

For example,

IDL:

struct Product {

ProductName name;
ProductVersion version;

};

maps to:
XML:
<TypeSpec>

<Struct name=“Product”>

<Field name=“name”>

<TypeSpec>

<ScopedName name=“SdeskApp.ProductName”/>

</TypeSpec>

</Field>

<Field name=“version”>

<TypeSpec>

<ScopedName name=“SdeskApp.ProductVersion”/>

</TypeSpec>

</Field>

</Struct>

</TypeSpec>

Sequences

The <Sequence> tag is used to represent IDL sequences. There is a bound attribute that denotes the sequence's length. See typedefs (next section) for an example.

Typedefs

Typedefs are mapped to <Alias> tags. The typedef name is as always given in the <Alias> tag's name attribute. Inside this element, the type is defined.

For Example,

IDL: typedef sequence<TrackerEvent> TrackerLog;
maps to:
XML <Type Spec>

<Alias name=“TrackerLog”>

<TypeSpec>

<Sequence bound=“0”>

<TypeSpec>

<ScopedName name=“SdeskApp.TrackerEvent”/>

</TypeSpec>

</Sequence>

</TypeSpec>

</Alias>

</TypeSpec>

Arrays

The <Array> tag is used to represent arrays. <ArrayBound> tags are used to represent array bounds through the value attribute. The type of the array is defined in a <TypeSpec>

For example,

IDL:
typedef float ChargePlan[7][24];
maps to:
XML:
<TypeSpec>

<Alias name=“ChargePlan”>

<TypeSpec>

<Array type=“string”>

<ArrayBound value=“7”/>
<ArrayBound value=“24”/>

<TypeSpec>

<BaseType name=“float”/>

</Type Spec>

</Array>

</TypeSpec>

</Alias>

</Type Spec>

Interfaces

The <Interface> tag is used to represent interfaces. A name attribute is used to denote the name of the interface. If the interface inherits from another interface, then the Interface element contains in an <Inherits> element. This element has an attribute called ScopedName, which holds the scoped name to the interface from which the interface inherits.

For example,

IDL:
interface SupportRequest : SomeModule::Request
{};
maps to:
XML:
<Interface name=“SupportRequest”>

<Inherits scopedname=“SomeModule.Request”/>

</Interface>

1.11 Attributes

The <Attribute> tag is used to represent attributes of an interface. The attribute's name is given by the name attribute. IDL Attribute elements have a second readonly attribute to denote whether the attribute is read only.

For example,

IDL:
readonly attribute TrackerId ref;
attribute Progress progressToDate;
maps to:
XML:
<Attribute name=“ref” readonly=“true”>

<TypeSpec>

<ScopedName name=“SdeskApp.TrackerId”/>

</TypeSpec>

</Attribute>
<Attribute name=“progressToDate” readonly=“false”>

<TypeSpec>

<ScopedName name=“SdeskApp.Progress”/>

</TypeSpec>

</Attribute>

Operations and Arguments:

The XML <Operation> tag is used to represent IDL operations. The element has a name attribute denoting the operation name. The Operation Element also has a replyexpected attribute which denotes whether the operation is oneway.

The arguments of an operation are given in the <Argument> tag. Each argument has 2 attributes called name and direction. Direction is the direction the argument is going, “in”, “inout”, “out”, “return”. Name is the argument's name. The argument is of return type if its name is set to “return_value”. Each <Argument> element has a TypeSpec element denoting the argument's type.

If the operation raises an exception then a <Raises> tag is used. The scoped name of he exception is given in a scopedname attribute.

For example,

IDL:
void remove();
void process(in TrackerEvent progress_update,

in Progress new_status);

void audit_trail(out TrackerLog recent_changes);
maps to:
XML:
<Operation name=“remove” replyexpected=“true”>

<Argument name=“return_value” direction=“return”>

<TypeSpec>

<BaseType namer=“void”/>

</TypeSpec>

</Argument>

</Operation>
<Operation name=“process” replyexpected=“true”>

<Argument name=“return_value” direction=“return”>

<TypeSpec>

<BaseType name=“void”/>

</TypeSpec>

</Argument>
<Argument name=“progress_update” direction=“in”>

<TypeSpec>

<ScopedName namer=“SdeskApp.TrackerEvent”/>

</TypeSpec>

</Argument>
<Argument name=“new_status” direction=“in”>

<TypeSpec>

<ScopedName name=“SdeskApp.Progress”/>

</TypeSpec>

</Argument>

</Operation>
<Operation name=“audit_trail” replyexpected=“true”>

<Argument name=“return_value” direction=“return”>

<TypeSpec>

<BaseType name=“void”/>

</TypeSpec>

</Argument>
<Argument name=“recent_changes” direction=“out”>

<TypeSpec>

<ScopedName name=“SdeskApp.TrackerLog”/>

</TypeSpec>

</Argument>

</Operation>

Unions

IDL unions are complex types made up of discriminators, case labels and default case labels. The <Union> tag is used to represent unions, and a name attribute is used to specify the name. The union's discriminator is given in the <Discriminator> tag. Embedded in this element is a <TypeSpec> for the discriminator's type. Each case label has <Case> element. The Case element has two attributes, label and name. The label attribute is the label name, and the name attribute is the applied name. Embedded in each <Case> element is the label's type, specified in a <TypeSpec>. For default case labels the label attribute is set to “default”.

For example,

IDL:
enum SICType {sic_rt, sic_cp, sic_na };

union SIC switch ( SICType ) {

| | |
|---|---|
| case sic_rt: | float rate; |
| case sic_cp: | ChargePlan chargePlan; |
| case sic_na: | NumberAnalyses numberAnalyses; |
| default: | string error; |

};

maps to:
XML:
<TypeSpec>

<Union name=“SIC”>

<Discriminator>

<TypeSpec>

<ScopedName name=“SICTeller.SICType”/>

</TypeSpec>

</Discriminator>
<Case label=“sic_rt” name=“rate”>

<TypeSpec>

<BaseType name=“float”/>

</TypeSpec>

</Case>
<Case label=“sic_cp” name=“chargePlan”>

<TypeSpec>

<ScopedName name=“SICTeller.ChargePlan”/>

</TypeSpec>

</Case>
<Case label=“sic_na” name=“numberAnalyses”>

<TypeSpec>

<ScopedName name=“SICTeller.NumberAnalysis”/>

</TypeSpec>

</Case>

<Case label=“default” name=“error”>

<TypeSpec>

<BaseType name=“string”/>

</TypeSpec>

</Case>

</Union>

</TypeSpec>

User Exceptions

The <Exception> tag is used to represent user exceptions. Its name is given in the name attribute. Like Structs, the <Field> tag is used to represent each field in the exception element, and each field's name is given in the name attribute of the <Field> tag. The type of the field is specified with a <TypeSpec> tag.

For example,

IDL:
exception BookedOut
{

string alternative;

};

maps to:

XML:

<Exception name=“BookedOut”>

<Field name=“alternative”>

<TypeSpec>

<BaseType name=“string”/>

</TypeSpec>

</Field>

</Exception>

Constants

The <Constant> tag is used to represent constants. This element has two attributes, name for the constant's name and value for the constant's value. Embedded in the <constant> element is a <TypeSpec> Element. The only valid TypeSpecs are BaseTypes and Aliases. Octet and enumerated constants are preferably not supported.

For example,

IDL:

const float PRICE = 5.50;

maps to:
XML:

<Constant name=“PRICE” value=“5.50”>

<TypeSpec>

<BaseType name=“float”/>

</TypeSpec>

</Constant>

Generation of Metadata from Java objects

Metadata is generated from Java 2 Enterprise Edition (J2EE) Enterprise Java Beans (EJBs) by performing Java reflection on the desired EJBs. This involves using the standard Java package java.lang.reflect to extract information about the operations provided by a given EJB, and the types involved in those operations. An abstract syntax tree may be generated using the extracted reflection information. A tree walker is then used to apply a Java to XML mapping similar in nature to the CORBA IDL to XML mapping described above. In general, this can be extended to any Java class accessible via the Remote Method Invocation (RMI) interface, and more generally, to any system supporting introspection.

From reflection information, the system generates both metadata and stub code. The stub code takes the internal representation of a SOAP request and does the necessary low-level data conversions before invoking the appropriate EJB stub. Exceptions and return values are passed back to the SOAP processing module in to generate SOAP exceptions or replies, respectively. A mapping similar to that described in detail for the example preferred CORBA embodiment described above is used.

Generation of Metadata for Message-Oriented Middleware and other Non-object-oriented Systems

Many enterprise systems are built on non-object-oriented foundations; Message Oriented Middleware (MOM) is a good example. In a MOM-based system, untyped or loosely typed messages are routed from client to server in an asynchronous fashion.

A good example is IBM's™ MQSeries™ MOM product. In MQSeries, messages are treated as opaque by the queuing system, and must be hand-marshaled and unmarshaled at each end. Many developers use XML as a means of providing some type-information in the messages that send using MQSeries, and this provides an opportunity to use the present invention for Web access to back-end MQSeries users. Metadata can be generated from XML Schemas or DTDs corresponding to the XML formats used by the messaging system.

Generation of HTML from Metadata

Referring again to FIG. 5, Web client generator 560 preferably generates HTML for invoking back-end server objects based on the XML metadata 555 generated by metadata generator 550. Returning to FIG. 8, HTML generation may be alternatively be performed using the abstract syntax tree 820 without first generating and storing XML.

In the example preferred embodiment schematically illustrated in FIG. 8, the Web client generator uses a parser compliant with the W3C Document Object Model (DOM) to create an in-memory representation of the XML document 860. The Metadata Library 860 maps a set of interface descriptions to an application name. The Metadata Library constructs, from the repository, a single composite XML Document 860 that contains all the NameSpaces and Interfaces for the application name. A query interface is provided by the Metadata Library to allow the generator to find scoped names within the metadata.

Annotation of Metadata

The web client generator traverses the XML document 860 representing the application using the XML DOM model, annotating the XML document 860 with information needed to generate HTML. HTML pages are generated from the annotated document. These steps are implemented by Walker classes—the Metadata Walker 850 for traversing and annotating the metadata, and the Generation Walker 840 for traversing the annotated metadata generating pages of the web client application.

For a CORBA application, the annotations represent HTML corresponding to XML metadata elements according to the IDL-to-HTML mapping described below, and are attached to the respective elements in the metadata by the Metadata Walker. For example, operations are annotated with HTML corresponding to request and response pages. Within an operation, each parameter is annotated with HTML corresponding to its type.

Any other data necessary for page generation is attached to the elements of the annotated Metadata Document as attributes. For example, if an interface has attributes, an attribute ‘hasAttributes=“true”’ will be added to the <Interface> element in the Document.

The Metadata Walker class is composed of operations for processing constructs of the Metadata structure described in the Metadata Schema (set forth in Appendix A). For example, a processMetadataNamespace operation is provided for processing a “Namespace” element, a processMetadatalnterface is provided for processing an “Interface” element, and a processMetadataOperation is provide for processing an “Operation” element, etc. These operations each preferably have a signature like the following:

void processMetadataConstruct(org.w3c.dom.Node node);

where Construct is the name of the construct which the operation was designed to process. These Metadata construct operations generally check to see if the node passed is an instance of Construct, retrieve any required and optional attributes of Construct, retrieve a list of child nodes, and process the child nodes, allowing only elements that constitute Construct.

For example, given the following Metadata fragment:

<Metadata>

<Interface name=“Foo”>

<Operation name=“op1” replyexpected=“true”>

<Argument name=“return_value” direction=“return”>

<TypeSpec>

<BaseType name=“long”/>

</TypeSpec>

<Argument name=“arg1” directiow=“in”>

<TypeSpec>

<BaseType name=“string”/>

</TypeSpec>

</Argument>

</Operation>

</Interface>

</Metadata>

The top-level operation walk() would expect and find the <Metadata> element as the node passed to it. It would expect any of a type or exception definition, a namespace definition or an interface definition. It would find the <Interface> element and pass this element into the processMetadatalnterfaceo operation. The processMetadataInterface() would expect any of an exception, attribute or operation definition. It would find the <Operation> element and pass it to the processMetadataoperation() operation which would process it according to the rules in the Metadata Schema.

Annotations are created by using a Generated Product Factory. This is an implementation of the Abstract Factory Pattern described in Gamma, et al., “Design Patterns” (Addison Wesley Longman, 1995), which is incorporated herein in its entirety by reference. The pattern allows the construction of families of product objects to be separated from their concrete implementations. This means that the behavior of the Generator can be changed by “plugging in” different generated product factories. For example, generated product factories could be provided for BizTalk™, RosettaNet™, or other syntaxes.

In the preferred Web Client Generation embodiment, the concrete factory used is the HTMLGenerationFactory. This factory creates HTMLGenerationProducts.

The generated products in the preferred HTML embodiment are of 2 types, complete products (low-level products, such as basic type arguments) or open-close products. The latter are generated products that have an opening part, are composed of lower level products and then a closing part.

For example, the products generated for an operation in the processMetadataOperation() operation are performed by retrieving attributes for the operation name and reply expected; calling the Factory.createOperationOpening() method, which annotates the <Operation> element with the HTMLGenOperationOpening product; processing children, including arguments and exceptions raised; and calling the Factory.createOperationClosing() method, which annotates the <Operation> element with the HTMLGenOperationClosing product.

Any products corresponding to elements that can have child elements will have open and close products in this way. After annotation, during page generation the generation walker 840 will traverse these products in the correct order to enforce a page composition.

An example of an annotated Metadata Document is illustrated in FIG. 15. The generated products are all enclosed within annotation elements, such as <requestopen-phase-generated>. Annotation elements are enclosed within [CDATA] sections to preserve HTML syntax.

Generating HTML from annotated Metadata

The Generation Walker 840 shown in FIG. 8 traverses the annotated Metadata with the same rules for processing child elements described above for the Metadata Walker driven by the Metadata Schema (set forth in Appendix A).

Each traversal searches for an element type and has an associated match strategy to invoke generation for elements of this type. The top-level traversal searches for children of element types corresponding to Namespaces, Interfaces or Exception Definitions.

Using the example annotated metadata document from FIG. 15, the top level traversal would find the <Interface> element. An Interface traversal would be performed (i.e. a traversal of the metadata starting at this <Interface>). Associated with an interface traversal is an Interface Match Strategy—a class with an operation to be called when an element in the annotated metadata document matches <Interface>. The Interface Match Strategy conforms to the Strategy design pattern described in Gamma, et al., “Design Patterns,” (Addison Wesley Longman, 1995),which is incorporated herein by reference.

The Strategy design pattern allows the Generation Walker 840 to define a family of algorithms for matching elements and to encapsulate each one in a Strategy class, and make them interchangeable. A Strategy lets the algorithm vary independently from clients that use it.

For example, the Interface Match Strategy creates a directory for the pages in the web client application needed for this interface; performs a traversal matching Operations; performs a traversal matching Attributes; and performs a traversal matching annotations for Contents page.

Continuing with the example from FIG. 15, the Operation traversal will match the <Operation> element for op1, and the OperationMatchStrategy is invoked. The OperationMatchStrategy creates a directory for the pages of the web client application needed for the op1 operation, performs a request page traversal, and performs a response page traversal. The rules for the request and response page traversals are governed by the annotations created in the first generation stage.

The elements that are matched in these traversals are annotation elements like <requestopen-phase-generated>. The request traversal is an in-order traversal of the entire <Operation> node and its children which employs the CDATAStreamMatchStrategy. This strategy streams the CDATA sections within annotations into a page buffer. When the traversal is complete the page buffer is written to disk. Cooperation between the generated products annotated and this in-order traversal means that the request page for the operation is composed correctly.

This scheme is more complex when pages have more than a single generation element. Response pages, for example are composed of a number of generated elements. This composition is represented by a PageCompositor.

A PageCompositor comprises a sequence of phases or composition tags that are generated by each element in an out argument in the correct order. For example, a return value from an operation that is a user defined IDL type that is a sequence of structs would yield a generated product for the struct that would comprise a number of separate annotations. One annotation is a JavaScript function (see below) to output the constituent fields of the struct. Another is a call to this function embedded inside the JavaScript processing the sequence.

The response generation traversal thus comprises a number of sequential in-order traversals matching a number of different tags corresponding to these separate annotations. The IDL-to-HTML mapping described below includes a description of how user types are decomposed, e.g. how a struct inside a sequence is to be mapped to HTML. This gives rise to a set of relationships between constructs and their parents.

As the walk of annotated metadata is performed, the relationships between constructs is stored in a stack, referred to as the Scope Stack. The Scope Stack records the construct being processed and an identifier. For example, the Scope Stack for the example of FIG. 21 when the in argument arg 1 is being processed is:

[Argument, arg1]

[BaseType,]

The mechanism for generating fragments for a given generated product is driven by the construct being generated, the direction of the argument, the phase or composition tag of the construct, and the parent construct. This information is all accessed from the Scope Stack.

The multi-dimensional nature of fragment generation means that there are hundreds of possible fragments. Each fragment is represented by its own class, each comprising a constructor that knows how to append the correct HTML fragment onto a buffer. The Java Dynamic Class Loader is then used to construct the correct fragment. The complete set of fragments comprise well-formed HTML pages 845.

The name of the class is composed as follows by concatenating the information in the Scope Stack:

Fragment Class Name=<Composition Tag>+<Product>+In+<Parent Product>

For the arg 1 in argument from the example in FIG. 21 the “HTMLRequestTextInArgument” Fragment is constructed for the in parameter.

The same mapping used to generate fragments is used to map POSTed HTML forms from inward parameters in request pages into SOAP Requests and to map SOAP replies with outward parameters into JavaScript variable blocks to be embedded into served response pages.

FIG. 6 schematically illustrates the generation of Web applications 605 by web client generator 560 for invoking CORBA objects that are described by XML interface description metadata 600. The Web applications 605 comprise a complete HTML client system for invoking the CORBA objects described by interface description metadata 600 and viewing the responses. In a typical application, the generated Web applications 605 are customized by web development staff and incorporated into a web application that uses the CORBA objects. The Web client generator 560 creates complete, fully functional Web clients. No additional development is required.

Since the generated representation is created using HTML and JavaScript and does not rely on any proprietary extensions, applets, tags, or plug-ins, the generated client is portable. The generated HTML can be edited for style, content, and presentation using popular Web-authoring tools and without any CORBA-specific knowledge.

The principal objective of the IDL-to-HTML mapping is to provide a Web client for a CORBA application interface (expressed in IDL), which can be used from within a browser to submit an invocation to a back-end CORBA component. The generated Web clients can be modified for style, presentation, and content by Web authors.

Given that the Web client is intended for human usage, normal conventions are followed with regard to well-formed, usable HTML-based Web pages. This assumes that the IDL specification is also well-formed for human interaction, that is, it does not contain overly complex types or types which require programming intervention (for example, manipulation of ‘any’ types or object references).

The purpose of the HTML representation is to drive interaction with a back-end component. It supports the invocation aspects of a back-end server program, namely invoking operations and modifying attributes of an interface described in XML metadata. This means that definitions within an interface definition, such as typedefs and structs need not appear explicitly within the HTML, but are resolved when invoked.

The end user need not resolve complex types such as sequences and structs into individual fields. The system automatically resolves the HTML of the interface down to basic types and strings. For example, if a struct contains three strings, the user is presented with three text input boxes in the HTML representation. Likewise, multiple fields matching the number of array elements are used to represent arrays. Recursion is supported to allow nesting of structs, arrays, and other elements within IDL interfaces.

The basis for an operation invocation is a pair of pages: the first page is based on an HTML form for submitting the request and the second HTML page displays the response.

After generation, Web client pages 605 can be copied to the document root directory of a Web server and used immediately. The representation consists of HTML files organized hierarchically (using a directory tree) to reflect the organization of the IDL specification.

Three considerations with regard to the nature of the HTML representation for IDL mapping are whether the particular HTML comprises a request or a response; whether a response is bounded or unbounded; and attributes.

Request pages that represent parameters for invoking an operation are based on HTML forms. Basic types representing in or inout parameters are mapped to HTML input fields (for example, <input> or <select>). Response pages display the results of an invocation. Therefore, basic types, representing inout, out, and return values map to JavaScript calls that write the contents of JavaScript variables to a page. In short, the mapping for an IDL entity depends on the data direction, that is, whether it's part of a request or a response.

The bounded or unbounded nature of a response has major implications for the structure of the Web client. Bounded arrays and sequences can be easily represented in HTML—multiple instances of the required HTML are created corresponding to the number of elements in the array or sequence.

However, in the case of unbounded sequences, it is not possible to specify the number of page elements at generation time. Imposing the limitation that all sequences must be bounded is unacceptable, as this would prevent effective representation of search results, for example, which are invariably dynamic in nature and therefore unbounded. Dynamic behavior is facilitated through the use of JavaScript. JavaScript finctions are used to dynamically create HTML based on the actual size of the response sequence.

All attributes of an interface are preferably clustered onto a single page (again based on an HTML form) with action buttons to both submit attribute updates (‘set’) and to request that the page be updated with the latest attribute values (‘get’). Clustering of attributes onto a single page avoids the need for separate HTTP requests for each individual attribute, thereby optimizing traffic between the Web client and the back-end server.

IDL-to-HTML Mapping

The following sections specify the IDL-to-HTML mapping used by the example preferred CORBA Web client generator.

Modules

In the preferred embodiment, a directory is created for each module within a specification. Each directory in turn contains subdirectories that represent the interfaces within the module, which in turn contain HTML files representing attributes and operations. For example, FIG. 7 illustrates a directory structure and HTML files generated for an interface myInterface described by IDL 700 of module myApp. Web client generator 705 acts upon an XML metadata description of IDL 700 to generate directories myApp 710, myInterface 715 and op 745, corresponding to the module myApp, the interface myInterface of module myApp, and operation op of interface myInterface.

Interfaces

Web applications stored as HTML files represent each IDL interface. An example Web application for the interface“myInterface” 700 is illustrated in FIG. 12. In the preferred embodiment, Web applications representing an interface are organized in four frames. Banner frame 1204 comprises a cosmetic area that displays the name of the operation, and is stored in the banner.html file 720 illustrated in FIG. 7. Contents frame 1201 displays links to the operations and attributes of the interface and is stored in contents.html 725 shown in FIG. 7. Main frame 1202 is the target frame for all attribute and operation request/response pages. Most of the generated pages are intended for loading and use in the main frame. The default page for myInterface is stored in index.html 735 shown in FIG. 7 and provides information about the interface, as rendered by a browser in man frame 1202 in FIG. 12. Copyright frame 1203 comprises a cosmetic area that holds copyright and URL details.

Selecting a link representing an operation in the contents frame 1201 such as the link for operation op 1205 loads the page for invoking the operation into the main frame 1202. The page for invoking the operation is stored in a directory named for the operation, such as directory op 745 in FIG. 7. The op.html page 750 is shown as rendered in a browser in FIG. 13. The IDL for operation op is rendered in the request page illustrated in FIG. 13 in accordance with the rules described above. Input fields 1301, 1302 for the in parameters arg1 and arg2 of operation op are provided, along with a button for causing the browser to send an HTTP request to Web server 525 including the information needed to invoke the op operation on the myServer instance of the myApp object.

When gateway servlet 530 shown in FIG. 5 receives the HTTP request, it transforms the request into a SOAP request and transmits the request to the XML engine 535 which in turn invokes the op operation on the myServer instance of the myApp object. The myStruct out parameter m is passed back to the gateway servlet, 530 which populates the op_response.html template and provides the populated HTML page to the Web server 525 which in turn transmits the populated op_response.html page back to the browser. The browser renders the op_response.html page as illustrated in FIG. 14.

Identifier Names

When generating the Web client 605, the Web client generator checks to ensure the IDL identifier names, including operation identifiers, do not clash with reserved JavaScript keywords. An underscore (_) is prefixed to the identifier if a clash is detected. The system handles the addition or removal of such underscores automatically. Therefore, no modifications are required to the back-end server or its IDL specification.

Parameter and Attribute Identifiers

As indicated in earlier sections, each operation is mapped to a request/response pair of HTML pages. Parameter identifiers are mapped to one or more form fields in the case of request pages, or one or more JavaScript variables in the case of response pages.

Attributes are clustered onto a single HTML page, which is used to both view and modify the attribute values. Attribute identifiers are mapped to one or more form fields and to one or more JavaScript variables. For basic types and strings, there is a single form (<form>) field or JavaScript variable representing the parameter or attribute. This field or variable is assigned the same name as the parameter or attribute identifier.

For complex types such as structs, arrays and sequences, the parameter or attribute is resolved into its constituent parts. For structs, a separate form field or JavaScript variable is created for each member. These are scoped by prefixing the member identifier with the parameter or attribute identifier in order to prevent the clash of field or variable names within a page. For example:

IDL:
struct UserDetails {

string title;
string firstname;
string surname;

};
void register_user(in UserDetails customer);
or:
IDL:
attribute UserDetails customer;

is resolved into three form fields or JavaScript variables: customer_title, customer_firstname, and customer_surname.

In the same way, arrays and sequences are resolved into multiple variables. The naming convention is the parameter or attribute identifier with an underscore and index number appended. For example:

IDL:
typedef short passcode [4];
void enter_code(in Passcode numberlist);
or:
attribute Passeode numberlist;
is resolved into four variables: numberlist_0 through numberlist_3.
These rules also apply for cases where complex types contain further complex types.

For example, if we include a Passcode in Userdetails:

IDL:
struct Userdetails {

string title;
Passcode numberlist;
...
};

the following additional variables would be created: customer_numberlist_{—}0 through customer_numberlist_{—}3.

The Web client generator checks for illegal use of IDL keywords as identifier names, as well as for name clashes with JavaScript keywords.

Operations

Each operation in an interface is mapped onto two distinct pages—one for submitting the request and one for viewing the response. This maps to the HTTP request/response model in which the parameters for a search are driven through a Web form and the response is returned in a separate page, which is specifically designed to list the required information using tables or lists. The data associated with an operation may consist of parameters (such as in, inout, and out) and possibly a return value. This request/response page-pair is organized into a request page and a response page as follows.

A request page named operation_name.html is generated, where operation_name is the name of the operation invoked using the request page. This request page contains a form (<form>) providing input fields for all in and inout parameters. It also contains a submit button with which the user issues the request to the back-end server application.

A response page named operation_name_response.html is generated, where operation_name is the name of the operation sending the response page. This page displays the results of the invocation, including all inout, out, and return values.

The generator creates a separate subdirectory for each operation under the top-level interface directory and writes the request/response pages to it. The directory is named after the operation. Also, it provides a link to the request page in the contents bar of the interface page.

As with all aspects of the generated Web representation, the Web author is free to alter the position and format (for example, fonts and colors) of all input and output fields provided that the field-naming conventions are observed, as outlined in the section Parameter and Attribute Identifiers above.

Return Values

Return values are treated as out-values with the JavaScript variable name set to return_value.

In, inout, out Parameter Attributes

As indicated above, the Web representation of IDL types depends on whether they form part of the request (in, inout) or are part of the response (out). The following sections discuss the various IDL types and constructs.

void Keyword

Operations qualified with the void keyword do not have return values, although they can possibly contain out or inout parameters. By default, a response page is always created even in the case where a void operation does not have any inout or out parameters. The Web author can decide on the appropriate text content for this page. This treatment differs from that of the oneway keyword below.

oneway Keyword

Operations qualified with the oneway keyword receive no response. The system creates a blank response page for such operations, because the typical HTTP model requires that a page be returned.

Attributes

All attributes for an interface are preferably clustered into a single page for efficiency, which allows all attributes to be set or retrieved using a single HTTP request. The attribute page is effectively a combination of request and response pages. Fields representing attributes are used to both view and modify attribute values (in CORBA terms, this corresponds to the notion of ‘get’ and ‘set’). Therefore, the rendering in HTML is identical to that for operation request pages. However, rather than writing the attribute value to a separate page (as is the case for operation-response pages), the input fields are simply set to the actual attribute values. For example, a basic type such as string is preferably mapped as follows:

<!——HTML——>

<input type=“TEXT”name=“attribute_identifier_name”/>

This is then set to the actual attribute value using:

<script type=“text/javascript” language=“JAVASCRIPT”>

document.formname.attribute_identifier_name.value=identifier_name; </script>

The JavaScript identifier_name is set to the actual attribute value when the page is loaded.

Mapping details for the various IDL types when used in attribute pages are provided in the following sections.

readonly Attribute

The readonly attribute is treated the same way as response parameters, that is, the value of the attribute is simply written using JavaScript write calls to the page. No input fields are created.

Basic Data Types

Most basic types are mapped to strings. All type-checking and conversion to CORBA types is performed by the system.

The system provides additional JavaScript ‘helper’ functions to aid aspects of client-side input validation. For example, fields representing numerical types will be checked to ensure that the entry is indeed numerical. In addition, ranges of integer types and the validity of floating point numbers are checked.

The following basic data types are treated as strings: short, long, unsigned short, unsigned long, float, double, char, octet. For parameter requests and attributes, these types are mapped to form input fields, for example:

<!——HTML——>

<input_type=“TEXT”name=“identifier_name”/>

For responses, the values corresponding to these basic data types are printed onto the HTML page using JavaScript:

<script type=“text/javascript”

language=“JAVASCRIPT”>document.write(identifier_name);</script>

For attributes, the field is set using JavaScript on page-load:

<script type=“text/javascript” language=“JAVASCRIPT”>

document.formname.identifier_name.value=identifier_name; </script>

The system automatically sets the value of the JavaScript variable identifier_name before the page is returned to the browser.

Boolean Types

In the case of requests, the Boolean type is mapped to either TRUE or FALSE (as a radio-button pair). For example:

<!——HTML——>

<input type=“RADIO” name=“identifier_name” value=“true”/>true

<input type=“RADIO” name=“identifier_name” value=“false”/>false

For responses, the value of the variable representing identifier_name (either true or false) is written directly to the page using JavaScript. The following example illustrates mapping boolean types in responses:

<script type=“text/javascript”

language=“JAVASCRIPT”>document.write(identifier_name);</script>

The value of both the HTML field (VALUE tag attribute) and the JavaScript variable representing a Boolean type must always be true or false, because the system requires these strings to determine the Boolean value. However, the Web author is free to change the page text representing the button as required, provided the value attribute is kept as true or false. Also, the Web author may insert additional JavaScript to check the variable (identifier_name) for the value true or false and write the appropriate string to the page. The following example illustrates mapping boolean types and adding Javascript.

<!-- Generated HTML/JavaScript -->
<input type=“RADIO” name=“identifier name” value=“true” />smoking
<input type=“RADIO” name=“identifier name” value=“false” />non-smoking
<script type=“text/javascript” language=“JAVASCRIPT”>
// JavaScript for Response
if(identifier_name == “true”) {

document.write(“smoking”);

} else {

document.write(“nonsmoking”);

}
</script>

For attributes, the radio buttons must be set to the correct value on page-load. This is achieved by means of a JavaScript ‘helper’ function, which examines the value of identifier_name and sets the checked property for the correct button to true. The generic helper functionality is automatically inserted by the Web client generator into the page as required. The following example illustrates mapping of boolean types for attributes:

radioHelper(document.formname.identifier_name, identifier_name);
// Generic Radio Helper (inserted by id12html)
function radioHelper(field_element, true_or_false) {

if(true_or_false == “true”) {

element[0].checked = “true”;
} else {

element[1].checked = “true”;

}

}

any Type

The IDL type any is not supported in the example preferred embodiment because this type is generally not useful outside the context of a CORBA environment.

Object References

The system handles object references for known types within a web representation. Known types are those that have been declared in the IDL specification parsed. Object references are preferably represented by links rendered graphically as images (using HTML <img> tags) to the appropriate interface page for that interface. This allows the user to select an object reference and click through to the set of operations and attributes for that object.

The link is created dynamically using JavaScript at runtime to allow for interface inheritance. The link is created using the actual returned object type. The following example illustrates mapping of object references:

document.writeln(“<a href=\“/ApplicationName/”+identifier.type+“/index.html?object=”+identifier.value+“\”target=\“parent\”><img src=\“/ SRLogo.jpg\”/><a>”);

The Web representation uses JavaScript and URL rewriting to pass the object reference details to the new page, thus removing the need to input the object reference details as you navigate through the HTML tree.

Object Interface Type

The system supports the use of the pre-defined interface Object, which enables you to indicate that an attribute or operation accepts any interface type. Using Object, you can write generic IDL operations, which enable you to accept and return object references to arbitrary interface types. Exchanging object references as Object types is useful for the creation of generic services when the precise interface types are not known at compile time. All IDL interfaces implicitly inherit from the Object interface type.

Interface Inheritance

Interface inheritance is supported through the aggregation of operations and attributes from inherited interfaces with the interface's own operation and attribute set. Inherited attributes appear within the attribute page (preferably inserted above the attributes of the interface). Inherited operations are listed in the contents frame for the interface (preferably above the operations of the interface).

Constants

Constants are resolved internally and used implicitly, where appropriate, when generating attribute and operation representations (for example, array sizes and string bounds). They are preferably not represented explicitly on the HTML pages, that is, no user-visible text appears to provide details on constants.

Enum Elements

For response pages and attributes, enums are represented using drop-down lists. The user selects the required input value from the list. The following example illustrates mapping of enum elements for responses and attributes:

IDL:
// IDL: sdesk:idl
// SDeskApp IDL
enum Status { under_investigation, further_info_requested,
PR_raised, fix_pending, closed, closed_fix_available };
maps to:
HTML:
<!-- Generated HTML -->
<select name=“identifier_name”>
<option value=“under_investigation”>under_investigation</option>
<option
value=“further_info_requested”>further_info_requested</option>
<option value=“PR_raised”>PR_raised</option>
<option value=“fix_pending”>fix_pending</option>
<option value=“closed”>closed </option>
<option
value=“closed_fix_available”>c1osed_fix_available</option>
</select>

For responses, the value of the variable representing the identifier is written directly to the page using JavaScript. The following example illustrates mapping enum elements for a response.

<script type=“text/javascript”

language=“JAVASCRIPT”>document.write(identifier_name); </script>

The value of the HTML field and the JavaScript variable representing enum elements must match the IDL enum element names in order to be processed correctly on request invocation. However, the Web author is free to change the page text representing list elements as required, provided the value attributes are kept identical to the enum element names. This can be useful because enum values cannot contain white space or punctuation characters. The page text can be used to provide a more usable or country-specific representation. The following example illustrates mapping enum elements with page text:

<!——Generated HTML——>

<select name=“identifier_name”>

<option value=“under_investigation”>Issue currently under investigation </option>

</select>

For attributes, the correct list element must be selected on page-load. This is achieved by means of a JavaScript ‘helper’ function, which examines the value of identifier_name and selects the correct element. The generic helper functionality is automatically inserted by the Web client generator into the page as required. The following example illustrates mapping enum elements for attributes:

<!-- Generated HTML/JavaScript -->
selectHelper(document.formname.identifier_name,identifier_name);
// Generic Select Helper (inserted by id12html)
function selectHelper(element, option_name) {

for(var i= 0; i < element.options.length; i++) {

if(element.options[i].value == option_name) {

element.options[i].selected = “true”;

}

}
}

Strings

The mapping for a string is dependent on whether it is bounded and, if bounded, on the size of the bound. For attribute and request pages, unbounded strings are mapped to input fields. The following example illustrates mapping unbounded strings:

<!——Generated HTML——>

<input type=“TEXT” name=“identifier_name”/>

If the string is bounded, the field length is set to the bound value, for example:

// IDL

string<30> email;

<!——Generated HTML——>

<input type=“TEXT” name=“identifier_name” size=“30” maxlength=“30”/>

A multi-line text field is used if the bound is more than a pre-configured length, preferably 50 characters. The following example illustrates mapping of long bounded strings:

//IDL
string<200> postalAddress;
<!-- Generated HTML -->
<textarea name=“identifier_name” cols=“50” rows=“4” wrap=“true”>
</textarea>

Typedefs are resolved internally and used implicitly, where appropriate, when generating attribute and operation representations. They are preferably not represented explicitly on the HTML pages, that is, no text appears to provide details on typedefs.

Structs

Structs are resolved down to their constituent members, that is, basic types or strings. This is performed recursively to allow nesting of complex types (such as structs and arrays) within an IDL interface. Graphically, members of a struct are grouped into a table to represent the association between the fields and to aid general page alignment. The table has one row for each member and each row has two columns—one listing the member name and the other containing the HTML representation for the type. The identifier_name is preferably indicated above the table. The following example illustrates mapping of structs:

IDL:

```
//From SDeskApp IDL
struct Customer {
  string firstname;
  string<30> email;
  string<200> postalAddress;
};
maps to:
<!-- Generated HTML -->
<p><b>identifier_name</b></p>
<br />
<table cellpadding=“2” cellspacing=“2” border=“1”>
<input type=“HIDDEN” name=“_struct” value=“identifier_name” />
<tr>
<td>firstname</td>
<td><input type=“TEXT” name=“identifier_name_firstname”/></td>
</tr>
<tr>
<td>email</td>
<td><input type=“TEXT” name=“identifier_name email” size=“30”
maxlength=“30” /></td>
</tr>
<tr>
<td>postalAddress</td>
<td<textarea name=“identifier_name_postalAddress” cols=“50”
rows=“4” wrap=“true”>
</textarea
</td>
</tr>
</table>
```

The Web client generator preferably automatically includes a hidden field to mark identifier_name as a struct. This is used internally by the system to interpret form data correctly.

Unions

The Web client generator supports unions as they are defined in the CORBA 2.3 specification. In the case of request or attribute pages, the desired type for a discriminated union can be set by the user by means of radio buttons. The Web client generator creates buttons for each case label within the union declaration. For response pages, JavaScript functionality ensures that only the selected union type (based on the discriminator setting) is displayed. This takes the form of a generated union-specific function containing a JavaScript switch.

The system uses a reserved descriptor/suffix to convey the discriminator value. This is used to form the radio-button names for request and attribute pages, so that selecting a button sets the discriminator value accordingly. Similarly, for an output parameter or returned attribute value, the union is represented by a JavaScript object with the discriminator value property set to the discriminator value. The declarators within the union are handled similarly to members of a struct. However, for response pages, all rendering is handled within JavaScript functions, which allows the pages to be dynamically rendered according to the returned discriminator value.

Arrays

Arrays are treated as multiple copies of the array element type subject to the name scoping rules described above. An index is appended to the identifier name to indicate ordering of entries within the array. If the array includes complex types such as arrays or structs, these are resolved into constituent elements. The following example illustrates mapping of arrays:

```
//IDL
interface foo {
  typedef string NameList[4];
  void enternames(in NameList names);
};
maps to:
<!-- Generated HTML -->
<p><b>names</b></p><br/>
<table cellpadding=“2” cellspacing=“2” border=“1”>
<input type=“HIDDEN” name=“_array” value=“names”/>
<tr>
<td><input type=“TEXT” name=“names_0”/></td>
</tr>
<tr>
<td><input type=“TEXT” name=“names_1”/></td>
</tr>
<tr>
<td><input type=“TEXT” name=“names_2”/></td>
</tr>
<tr>
<td><input type=“TEXT” name=“names_3”/></td>
</tr>
</table>
```

The Web client generator preferably automatically includes a hidden field to mark identifier_name as an array. This is used internally by the system to interpret form data correctly for arrays.

Sequences

Bounded sequences are treated in the same way as arrays. Multiple HTML entities are created according to the sequence bound value. For request pages and attribute pages, it is necessary to arbitrarily force a bound on a sequence, because the actual number of elements is unknown. Preferably this enforced bound is configured in a configuration file, and defaults to 3.

A more dynamic approach is preferred in the case of response pages, which allows responses of arbitrary length to be returned and rendered accordingly. JavaScript is used to facilitate this because static HTML cannot adjust to the number of elements returned in an unbounded sequence. Unbounded sequences of complex types such as structs are preferably supported (in addition to basic types and strings). Tabulated response data are typically represented via unbounded sequences of structs with the members of the struct mapping onto table columns.

The JavaScript-based representation for an unbounded sequence is closely tied to the way in which response data is included (as a set of JavaScript variables) in the response page. In the case of unbounded sequences, a JavaScript array containing a list of the response data is included in the variable block. By determining the size of this array, a JavaScript function created by the Web client generator can determine the number of entries in the sequence and dynamically write a corresponding number of HTML elements to the page, thereby scaling the page in-line with the size of the response data. The mapping for the types within the sequence is as described above.

This approach differs findamentally from the usual response page structure, where static HTML is used to render response data. Also, in the case of unbounded sequences of structs, additional JavaScript functions are created by the Web client generator for each struct type. The following example illustrates mapping of sequences:

```
//IDL
interface foo {
  typedef sequence<string> NameList;
  void getnames(out NameList names);
};
maps to:
<!-- Generated HTML/JavaScript -->
<script type=“text/javascript” language=“JAVASCRIPT”>
//NameList
function do_names array(array) {
  document.writeIn(“<table cellpadding=“2”
  cellspacing=“2” border=“1”>”);
  for(var i = 0; i < array.length; i++) {
  document.writeIn(“<tr>”);
  document.writeIn(“<td>“ + array[i] + “</td>”);
  document.writeIn(“</tr>”);
  }
  document.writeIn(“</table>”);
}
</script>
<script type=“text/javascript” language=“JAVASCRIPT”>
//Invoke function on page_load to process unbounded sequence
//entries.
//names_array_0 is created in the Variable block
do_names_array(names_array_0);
</script>
```

Exceptions

Separate pages are generated for each exception. These pages display any exception-specific data and can be tailored by the Web author. The appropriate exception page is returned by the system servlet 530 when an exception is raised by the back-end CORBA server 540.

The XML Engine

Turning again to FIG. 5, the XML engine 535 provides mapping services between Web technologies such as SOAP and HTML generated by the Web client generator described above and back-end server systems.

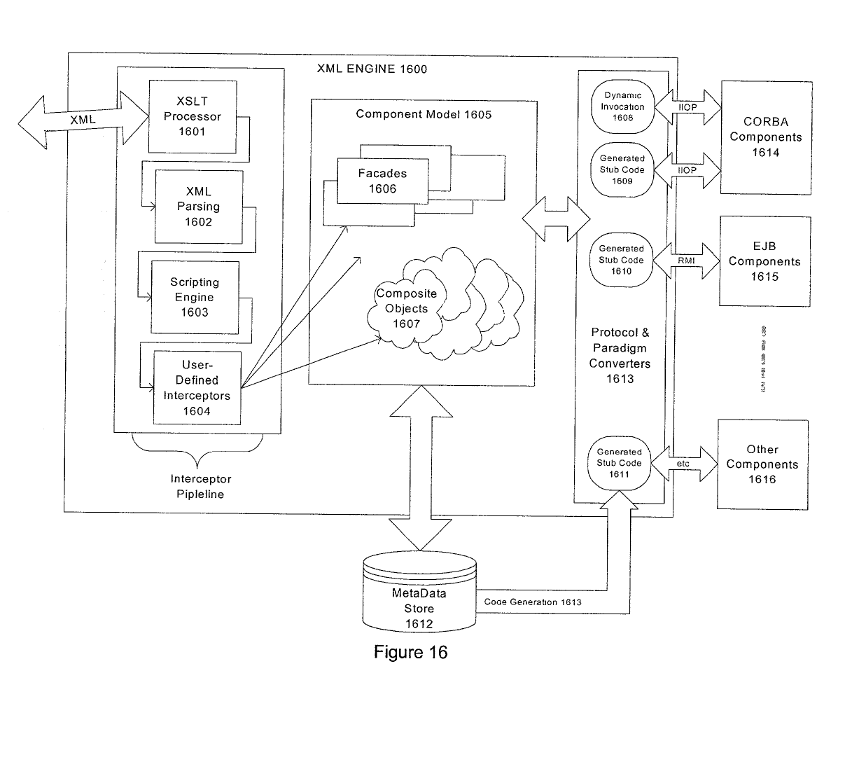

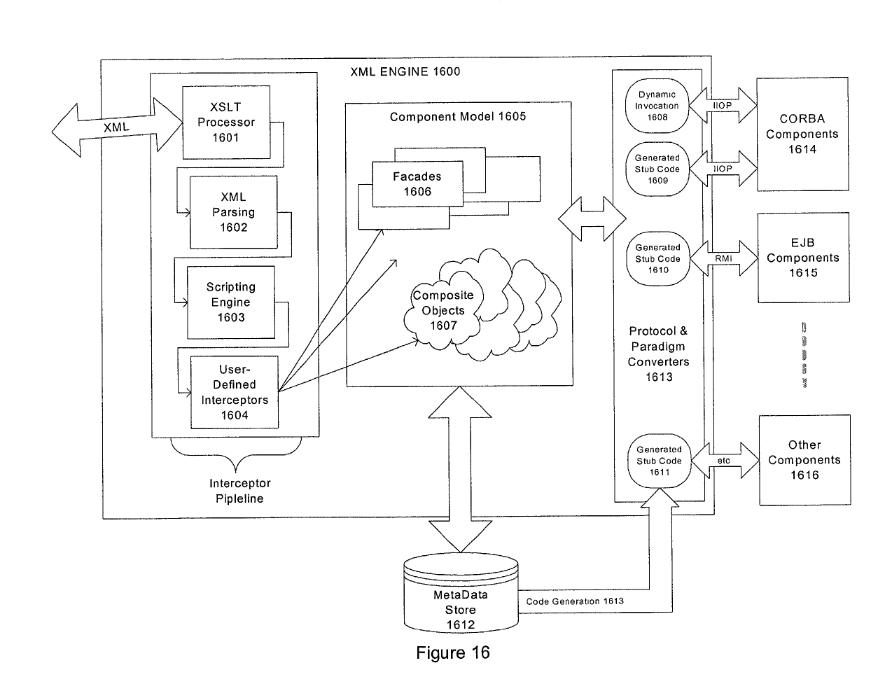

As schematically illustrated in FIG. 16, in a preferred embodiment, the XML Engine 1600 combines XSLT processor 1601, XML parser 1602, scripting engine 1603, user-defined interceptors 1604, component model 1605 comprising facades 1606 and composite objects 1607, and protocol and paradigm converters 1613 such as CORBA Dynamic Invocation Interface 1608, CORBA generated stub code (static interface invocation) 1609, EJB generated stub code 1610 and generated stub code 1611 for other components such as MOM.

XSLT defines a standardized XML-based way of describing a mapping between one XML document and another (see http://www.w3.org/TR/xslt). The W3C has also defined XPath, which is a standardized mechanism for accessing individual parts of an XML document (see http://www.w3.org/TR/xpath). Together, XSLT and XPath provide everything required to transform XML documents, in whole and in part.

XSLT provides for a structural mapping of XML documents. There have been attempts to add extra functionality to perform simple semantic transformations, but this complicates the language, and there are definite limits to what may be achieved inside an XSL processor. For example, consider the case where an XML document must be mapped onto a new format, but must also have certain values updated based on some dynamic data that is not available at the time the XSL script was written (such as currency conversion rates). To support this, XSLT needs to be supplemented with additional code hooks to allow corporate developers to perform complex transformations, filtering, message re-routing, etc.

To this end, the XML engine 1600 provides a generic mechanism for message interceptors. The interceptors are based on the Interceptor design pattern known to those of skill in the field of middleware programming, and permit services to be added transparently and triggered automatically. A group of related interceptors forms an interceptor chain or pipeline. The Interceptor design pattern is described in Schmidt, et al., “Pattern-Oriented Software Architecture: Patterns for Concurrent and Networked Objects” (Wiley & Sons, 2000), which is incorporated herein in its entirety by reference. Interceptors are a form of callback that may be registered and called in response to events.

Interceptors 1604 preferably process a message as it moves through the system, after it has been through XSLT mappings, and after it has been parsed by an XML/SOAP parser, but before it is passed to the protocol and conversion layer 1613 for conversion to a back-end component invocation.

These interceptors have access to the complete contents of the message (both requests and replies), and can preferably do any of the following: leave the message unchanged (e.g., a logging interceptor might record the message, but the unmodified message will be sent to the back-end system as usual); modify the message (e.g., convert a currency argument from dollars to yen); consume the message, (i.e., handle the request itself, either internally within the interceptor, or by calling some other code); or reject the message, (i.e., the interceptor can throw an exception that will abort the request and be passed back to the client).

Interceptors are supported for inbound (e.g. invocation) and outbound (e.g. response) messages. Interceptors are preferably implemented as Java classes, and registered with the XML engine using an XML document that identifies the types of messages which will be processed by each registered interceptor and the number of instances of the interceptor that should exist (e.g. one per message, or one for all messages). An example XML document for registering an interceptor with the XML engine is set forth in FIG. 23. In the example, explanatory comments follow “--” and are not a part of the XML document.

Incoming messages are intercepted on a per-target basis and routed to either a facade object 1606 or a composite object 1607. Facade objects 1606 and composite objects 1607 are based on the facade and composite design patterns described in Gamma, et al., “Design Patterns” (Addison Wesley Longman 1995). Interceptors 1604 differ from ordinary interceptors in that they are also tied into the Metadata repository. Facades and composites preferably have corresponding metadata entries that describe their interfaces. Because of this, the system can use this metadata to generate HTML pages, XML Schemas, etc., in exactly the same way it would do for back-end components. To the client, both facades and composites look just like other objects. [[MORE DETAIL WOULD BE HELPFUL HERE]]

Interceptors 1604 allow Java code to be inserted into the XML engine 1600 message-processing pipeline. This Java code is unrestricted in what it may do. In a preferred embodiment, the system includes a pre-packaged scripting interceptor. This interceptor is built upon the same interceptor framework as described above, but embeds a server-side JavaScript engine. Developers may write interceptor code in JavaScript, and it will be executed by the script engine just as Java interceptor code is executed by XML engine 1600 message processor. This broadens the developer base considerably, as well as providing a safety net: errors in the interceptor scripts are contained within a secure “sand box” within an individual instance of the script engine, rather than within the XML engine 1600 as whole.

The same features available to interceptor programmers in Java are available through the JavaScript engine. They include: creating facade 1606 and composite 1607 objects; accessing the Metadata store 1612; and making back-end invocations (e.g. via 1608 or 1609).

Many facade objects 1606 are very simple. For example, a common use of a facade object 1606 is to hide parts of another object, or to rename parts of an interface. Facade objects 1606 can also be used to do type conversion (e.g., where the client sees a string field, this may need to be matched onto an integer code for the back-end component). Another very common case involves the composing (or “gluing together”) of several back-end components into a single facade, or the splitting of a single component into multiple facades. Many of these facade operations can be achieved through manipulating the metadata, and require no additional coding. The system preferably includes a facade editor to simplify these tasks. This editor provides a graphical view of the metadata components and allows a developer to construct the common facade objects describe above without having to write any code at all. The facade processing is handled within the run-time Metadata processing module.

SOAPDirect

Returning to FIG. 5, SOAPDirect application 515 is also seen communicating with Web server 525 and servlet 530. SOAPDirect is an API provided in another aspect of the invention to make back-end enterprise CORBA objects accessible to new Java applications without requiring the Java developer to learn SOAP or XML. Thus, SOAPDirect enables a development environment for efficient creation of new applications by traditional developers while allowing the applications to stay in tune with the rapid adoption of popular standards such as XML and SOAP.

While many SOAP APIs are available to create SOAP messages directed to servlet 530, SOAPDirect provides several additional advantages. SOAPDirect is limited in size and complexity in part reflecting its design for a specialized programming task. Furthermore, SOAPDirect insulates clients from changes in the message specifications while enabling integration with other XML document manipulating software. Thus, SOAPDirect also enables construction of a CORBA call as a SOAP message, using other XML documents as input.

SOAPDirect provides a simple model for calling IDL operations on CORBA objects using synchronous ‘requests’ and ‘replies’. A request is a message encoding an operation call while a reply is a message encoding the results of a call. A request contains the identity of the target component, the IDL operation that the client wants to call, and any parameter values required by this call. A reply includes the operation return value, parameters, and exception information.

The SOAPDirect interface contains the following Java classes (a) a class for creating and sending requests; (b) a class for reading replies; (c) classes for processing IDL data types in requests and replies; and (d) Exception classes. FIG. 9 provides a simplified overview of the SOAPDirect classes.

SDRequest enables creation and sending of requests. Each request represents a single call to an IDL operation. The SDReply class provides access to the results of an operation call. An SDReply object provides access to the operation return value, any returned parameter values, and any exceptions raised. The remaining SOAPDirect classes represent IDL data types that can form part of a request or a reply, for example, as operation parameters or return values.

There are three steps in preparing and sending a request with SOAPDirect: (a) create a request object; (b) add input parameters to the request; and (c) send the request.

To create an SDRequest object, an constructor method of the SDRequest class is called. One preferred constructor is invoked with the URL at which the CapeConnect servlet is located; an identifier for the target CORBA object preferably a stringified CORBA object reference or an object name from a CORBA naming service); the application name associated with application; the fully scoped name of the IDL interface in which the operation is defined; he operation name.

Input parameters are added to an SDRequest object using an add method of the SDRequest object. Parameters are defined using subclasses of the SDDataType class. For example, a numerical input (or other IDL basic type) may be added to an SDRequest object by first creating a new SDValue object encapsulating the numerical value, and then passing the SDValue object along with a name for the parameter to the add method of the SDRequest object.

When an SDRequest object is created, SOAPDirect constructs a SOAP message that contains details of an operation call. After all input parameters are added to the SDRequest object, the message is ready to be sent to the servlet 530 for processing. The invoke() method, defined on the SDRequest class, sends the SOAP message for the operation call to the servlet 530. When the servlet 530 receives a request, it forwards the request details to the XML engine 535. The XML engine calls the required CORBA operation and returns the results to the servlet. The servlet then sends a reply message, containing the results, to the client. The invoke() method blocks until it receives a reply from the servlet, or until it receives an exception indicating that it cannot communicate with the servlet. When the invoke() method receives a reply or an exception, it returns an SDReply object. This object enables access to the results of the operation call.

CORBA operations can have a single return value and any number of output parameters. The system sends these values to the SOAPDirect client in a reply message. The reply indicates that the operation succeeded and enables the client to retrieve the results. Both a return value and output parameters are optional in IDL operations. Some operations have no return value and no output parameters. If a SOAPDirect client successfully calls one of these operations, the reply message indicates that the call was successful but contains no output data.

One-way operations have a different communications model from other operations. When the XML engine calls a one-way operation, the call returns immediately. The ORB does not guarantee that the operation call is delivered to the CORBA object or that the object processes the call successfully. As a result of this communications model, one-way operations cannot return a value and cannot have any output parameters.

For both standard and one-way operations, three types of errors can occur when the SOAPDirect invoke() method is called to make a CORBA call: (1) CORBA exceptions are raised if an error occurs during communications between the XML engine and a CORBA object, for example, if the CORBA object does not support the IDL operation that the client tried to call. (2) SOAP faults are returned if an error occurs in SOAP communications between components, for example, if the servlet receives a badly formatted SOAP message from the SOAPDirect client. SOAP faults are also returned when a CORBA exception is raised. The details of the exception are sent to the client as a SOAP fault. (3) Java exceptions are thrown in the SOAPDirect client code if a local error occurs at the client, for example, if the client cannot communicate with the servlet.

The client may check for a SOAP fault by calling the getFault() method on the SDReply object returned from a CORBA operation call. If this method returns a non-null value, a fault occurred. A SOAP fault contains a fault code that indicates what type of error occurred; a fault actor that specifies the component at which the fault originated; and a fault string contains a human-readable description of the error that occurred. The fault detail provides additional information about the error. For example, if the fault was caused by a CORBA exception, the detail value contains information about the exception. The methods getFaultCode(), getFaultActor(), getFaultString(), and getFaultDetail() enable the client to read the code, actor, string, and detail values, respectively. When calling an IDL operation with SOAPDirect, the client checks for a fault before retrieving the return value or output parameters from an SDReply object.

SDReply objects are typically not created explicitly. Calling invoke() on an SDRequest object is the most common way to create an SDReply object. When processing the results of an operation call, the methods of the SDReply class enable the client to read the return value; read parameter values; and handle errors. A getReturnValue() is defined on the SDReply class, for reading the return value from an IDL operation call. The getReturnValue() method always returns an object of type SDDataType. The client casts this object to the SOAPDirect class that corresponds to the IDL data type returned by the called operation. A getArgument() method is defined on the SDReply class, for reading the value of a named parameter for an operation.

There are additional SOAPDirect mechanisms to enable customization of message created by SOAPDirect. In this regard, SOAPDirect enables (a) manipulation of messages as strings; and (b) adding header data to requests. For instance, SDRequest class 905 contains a tostring() method. Calling toString() on an SDRequest object converts the request to an XML document in string format. Processing the resulting XML document allows construction of a new request. The SDRequest class 905 includes a constructor that takes an XML document as a string and creates the corresponding SDRequest object.

The SDRequest class includes a method, addUserData(), for addition of strings in the form of name-value pairs to the header of a SOAP request. For instance, if the request is converted to a string and the resulting XML document sent to another component, that component can read and process the name-value pairs in the document's SOAP header.

Java Server Pages (JSP) provide a mechanism for a Web server to execute code to implement an operation coded in Java, and dynamically provide the results as a Web page. Using SOAPDirect with JSP permits scripting of calls to CORBA and other back-end servers.

FIG. 10 illustrates how SOAPDirect connects JSP to the XML infrastructure described, for instance in FIG. 5. When a user calls a JSP, the JSP employs CORBA calls to get dynamic information required by the user. In FIG. 10 Web server 1000 hosts JSP 1005 that, in turn, communicates with servlet 1010 via SOAP with the aid of SOAPDirect. Servlet 1010 forwards SOAP message from JSP 1005 to XML engine 1015. XML engine 1015 then makes a call on back-end CORBA object 1020 via IIOP. The results are communicated back to JSP 1005 as indicated by the bidirectional arrows. XML engine 1015 and servlet 1010 are similar to XML engine 535 and servlet 530 of FIG. 5. Moreover, while servlet 1010 shown in FIG. 10 is not implemented on server 1000, this is not a requirement but merely one of many possibilities. Similar considerations apply to XML engine 1015 and other modules.

In an embodiment of the invention, illustrated in FIG. 11, a development environment 1100 is provided to facilitate efficient development of Web applications suited to particular needs. Upon specifying an interface description 1105 such as IDL for CORBA object interfaces or for COM/DCOM objects, generating module 1110 automatically prepares Web applications 1115. Web applications 11 15 are advantageously nested such that a top level page corresponds to the interface, which, in turn is linked to a lower level page corresponding to an operation within the interface (of course, alternative embodiments can include more than one operation in a Web page). Each operation preferably corresponds to two Web applications—one for accepting input data for invoking back-end object 1140 and the other for receiving a reply from the back-end object 1140 and integrating the reply into the reply Web page.

As is readily appreciated, the automatically generated Web pages, while operational, may advantageously be modified to better reflect an application design. These modifications are directed principally to the Web pages' appearances. A Web designer need not have knowledge of IDL or back-end programming to perform such modifications.

Customization of the generated Web applications is conveniently managed with the use of customization tool 1135, for instance, by developer 1145. Customization tool 1135 typically is software such as FRONTPAGE™ manufactured by MICROSOFT™ Corporation of Redmond, Wash., or MACROMEDIA DREAMWEAVER™ or a text editor, or another suitable Web application editing software. Customization tool 1135 generates code to provide a desired look to the Web application by removing or replacing some elements, editing Javascript and the like, often via a GUI.

In addition to customization tool 1135, developer 1145 has access to Interceptor API 1150 for intercepting SOAP messages of choice as they are received by or sent from engine 1130 or the responding module 1125. Thus, following a specification of the types of messages that are of interest, developer 1145 can view the message traffic, consume a message of interest or modify a particular message prior to or after invoking object 1140, with the generation of a suitable response for the a Web client.

It should be understood taht the foregoing description is only illustrative of the invention. Various alternatives and modifications apparent to one having skill in the art without departing from the spirit of the invention are intended to be within the scope of the claims that follow. Accordingly, the present invention is intended to embrace all such alternatives, modifications and variances falling within the scope of the appended claims.

We claim:

1. A method of providing Web access to remote program, comprising the steps of:
automatically generating a Web application from a description of an interface of the program;
storing the Web application on a server accessible to a client;
transmitting the Web application to the client in response to a request by the client;
receiving an indication from the client for invoking the interface;
invoking the interface;
receiving a result from the program in response to invoking the interface transmitting a response Web application to the client based on the result.

2. The method of claim 1 wherein the program is CORBA-compliant.

3. The method of claim 1 further including the step of generating the Web application from the description of the interface with nested Web pages such that the interface corresponds to an interface Web page and an operation within the interface corresponds to an operation Web page, the interface Web page comprising a link to the operation Web page.

4. The method of claim 3 wherein the nested Web pages include a Web page for submitting data to invoke the interface.

5. The method of claim 4 further including the step of customizing one of the automatically generated nested Web pages to change the appearance of at least one automatically generated Web page.

6. The method of claim 4 further including the step of customizing the automatically generated nested Web pages by performing one act from a set consisting of adding an element, removing an element, removing a javascript element, replacing a form field with a fixed value, and preventing display of an element, in at least one of the automatically generated Web pages.

7. The method of claim 1 wherein the automatically generated Web application includes at least one web-page.

8. The method of claim 6 further including the step of customizing the nested Web pages in response to adding a new operation to the interface.

9. A method for transforming data represented in a first markup language into a second markup language comprising the steps of:
parsing the data to generate a parse tree reflecting the syntax of the data;
traversing the parse tree and annotating the parse tree by adding data to the parse tree representing an aspect of the data in the second markup language.

10. A method for invoking an object, comprising the steps of:
generating a description of the interface of the object;
generating metadata representing the interface of the object from the description;
storing the metadata;
generating a representation of an invocation of the object in a markup language from the metadata;
transmitting the representation of the invocation to a client program configured to invoke the object by interpreting the representation;
receiving an invocation from the client program;
based on the metadata, interpreting the received invocation.

11. A method for transforming data represented in a first markup language into a second markup language comprising the steps of:
invoking a factory object to obtain an instance of an product object conforming to an interface for generating a representation in the second markup language;
parsing the data;
invoking the product object with information derived from the parsed data to generate data representing an aspect of the data in the second markup language.

12. The method of claim 10, further comprising the steps of:
configuring the factory object to provide a different product object in response the invocation and an indication of a different second markup language.

13. A method for displaying a response to an invocation of a remote program, the response comprising data having a length unknown at the time of invocation, comprising the steps of:
transmitting a Web application comprising executable code for receiving a portion of the response having a length not known at the time of invocation and generating HyperText Markup Language for representing the received portion of the response.

14. A method for invoking a remote program, comprising the steps of:
receiving information including identifiers describing an interface of the remote program;
checking the identifiers for name clashes with a scripting language;
based on the received information, generating script for execution by a Web browser including identifier names that do not clash with the scripting language.

15. A system for processing an XML message, comprising:
an XSLT processor for transforming XML messages;
a callback registry;
one or more callback objects registered in the callback registry that are selectively activated according to registration information stored in the callback registry to process XML messages.

16. A method for converting an invocation on a remote object in a markup language into a native call, comprising the steps of:
transmitting the invocation, in the markup language, to a remote location;
interpreting, in response to receiving the invocation at the remote location, the markup language based on metadata representing an interface on the object;
making the native call on the object via the interface.

17. In a software environment for providing web-access to at least one CORBA object via simple object access protocol (SOAP) in a Java encoded object, a method for integrating SOAP interactivity in Java, the method comprising the steps of:
issuing, by a developer, an application program interface (API) call to cause construction of a request object in accordance with an operation and any required parameters for the operation;
sending a SOAP message containing a name for the operation and the required parameters for the operation to a target object via a SOAP processing server program;
creating a reply object based on executing the operation at the target object;
receiving a response, based on the reply object, from the SOAP processing server program.

18. The software environment of claim 17 wherein the reply object is created automatically in response to receiving the response from the SOAP processing server program.

19. The software environment of claim 18 wherein the Java encoded object is in a Java Server Page.
